(19) United States
(12) Patent Application Publication
(10) Pub. No.: US 2016/0204823 A1
(43) Pub. Date: Jul. 14, 2016

(54) 10GbE E-band radio with 8PSK modulation

(71) Applicants: John Lovberg, San Diego, CA (US); Richard Chedester, Whately, MA (US); Vladimir Kolinko, San Diego, CA (US)

(72) Inventors: John Lovberg, San Diego, CA (US); Richard Chedester, Whately, MA (US); Vladimir Kolinko, San Diego, CA (US)

(73) Assignee: Trex Enterprises Corporation, San Diego, CA (US)

(21) Appl. No.: 14/998,988

(22) Filed: Mar. 14, 2016

Related U.S. Application Data
(63) Continuation-in-part of application No. 12/930,947, filed on Jan. 20, 2011, now Pat. No. 9,300,508.
(60) Provisional application No. 62/282,671, filed on Aug. 7, 2015.

(51) Int. Cl. H04B 1/40; H04W 72/04

(52) U.S. Cl. CPC H04B 1/40; H04W 72/0453

(57) ABSTRACT

A millimeter wave radio link in which the transceivers have most of its components fabricated on a single chip or chipset of a small number of semiconductor chips. The chip or chipsets when mass produced is expected to make the price of millimeter wave radios comparable to many of the lower-priced microwave radios available today from low-cost foreign suppliers. Preferred embodiments of the present invention operate in the range of about 3.5 Gbps to more than 10 Gbps. The transceivers of a preferred embodiment are designed to receive binary input data at an input data rate in 10.3125 Gbps and to transmit at a transmit data rate in of 10.3125 Gbps utilizing encoded three-bit data symbols on a millimeter carrier wave at E-Band frequencies.

### CROSS REFERENCE TO RELATED APPLICATIONS

This application is a continuation in part of U.S. patent application Ser. No. 12/930,947 filed Jan. 20, 2011 which was a CIP of and Ser. No. 12/928,017 filed Nov. 30, 2010 (now U.S. Pat. No. 9,008,212) which was a CIP of Ser. No. 12/228,114 filed Aug. 7, 2008 (now U.S. Pat. No. 8,098,764), all of which are incorporated herein by reference. This Application also claims the benefit of Provisional Application Ser. No. 62/282,671 filed Aug. 7, 2015.

### FIELD OF THE INVENTION

The present invention relates to radio systems and in particular to radios having a large number of components fabricated on a single or small number of semiconductor chips.

### BACKGROUND OF THE INVENTION

### E-Band Radios

Telecommunications providers and others have attempted in the past to utilize the various wireless technologies for the delivery of last-mile communications services to businesses as an alternative to the installation of fiber. A viable wireless alternative to fiber needs to provide high-speed transmission rates, the ability to establish links between distances that are meaningful within a metropolitan area and the ability to power through rain and other weather conditions. In addition, a wireless alternative to fiber needs to be quickly deployable and materially more cost-efficient than fiber. A result of the physical characteristics of the portions of the spectrum in which current wireless technologies operate, and the performance limitations of the products based on these technologies, they fail to meet the criteria necessary to prove them viable alternatives to fiber.

In January of 2003, the United States Federal Communications Commission (with encouragement from Applicants' employer, Trex Enterprises Corporation, its subsidiary Loea Corporation and others) helped to enable a new rulemaking in which 10 GHz of bandwidth, comprising (E-Band) frequency channels. These bands were opened for short range, high bandwidth, point-to-point radio communications without restrictions on modulation efficiency.

The unique characteristic of this rulemaking was that for the first time a large section of bandwidth would be shared based on locational constraints rather than spectral (channelizing) constraints. Each user of the new frequency bands was free to use the entire available bandwidth (e.g. 5 GHz in each of the 71-76 GHz and 81-86 GHz bands) as long as the transmit/receive path was confined within a single very narrow channel (“pencil beam” less than 1.2 degrees wide) in 3-dimensional space. However, rain fade at E Band can reach up to 35 dB/km, versus 1 dB/km at 6 GHz, so much larger link margins must be maintained at E Band, relative to lower frequency microwave bands, to accommodate severe weather events. On the other hand, the 5 GHz channel bandwidths available at E-Band are more than twenty times as wide as the widest channels available at microwave frequencies, so data rates in the range of 1 Gbps (unheard of for microwave radios) are made possible using simple on-off keying or binary phase-shift keying.

Applicants' employer led the way in the development of the early millimeter wave radios. Several patents describing these early radios have been awarded to Applicants and their fellow workers and assigned to Applicants' employer. These patents include the following patents:

| PATENT NUMBER | ISSUED | TITLE |
|---|---|---|
| U.S. Pat. No. 6,556,836 | Apr. 29, 2003 | Point to Point Millimeter Wave Dual Band Free Space Gigabit per |
| | | Second Communication Link |
| U.S. Pat. No. 6,665,546 | Dec. 16, 2003 | High Speed Point-to-Point Millimeter Wave Data Communication |
| | | System |
| U.S. Pat. No. 6,714,800 | Mar. 30, 2004 | Cellular Telephone System with Free Space Millimeter Wave |
| | | Trunk Line |
| U.S. Pat. No. 7,062,283 | Jun. 13, 2006 | Cellular Telephone System with Free Space Millimeter Wave |
| | | Trunk Line |
| U.S. Pat. No. 7,065,326 | Jun. 20, 2006 | Millimeter Wave Communication System with a High Performance |
| | | Modular Circuit |
| U.S. Pat. No. 7,680,516 | Mar. 16, 2010 | Mobile Millimeter Wave Communication Link |
| U.S. Pat. No. 7,769,347 | Aug. 03, 2010 | Wireless Communication System |
| U.S. Pat. No. 8,098,764 | Jan. 17, 2012 | Millimeter Radio with Phase Modulation |
| U.S. Pat. No. 8,385,977 | Feb. 26, 2013 | Cellular Communication System with High Content Distribution |
| U.S. Pat. No. 9,008,212 | Apr. 14, 2015 | High Data Rate Millimeter Radio |

### Quadrature Amplitude Modulation

Two key conditions dictated early microwave radio designs for fixed point-to-point communications: 1) very limited available bandwidth in which to transmit as much data as possible, and 2) minimal dynamic range variation associated with rain fade and other weather or atmospheric variations. The first of these conditions dictated the adoption of very high-order modulation techniques such as quadrature amplitude modulation (QAM). For example, 64-QAM, 128-QAM, or 256-QAM systems are in use for microwave links in which several (such as 6 to 8) digital bits can be sent simultaneously using a single pseudo-digital symbol, thereby increasing spectral throughput (bits per second per Hertz), but using such modulation schemes, a penalty of 17 to 22 dB in transmitter power is incurred relative to single-bit symbol modulation (on-off keying or binary phase shift keying) to maintain a manageable bit error rate. The second key condition driving earlier designs, the comparatively lower atmospheric attenuation and weather fade characteristic of lower frequencies, made such modulation efficiency trades desirable for microwave radios, by requiring little additional link margin to cope with high humidity and heavy rainfall. These QAM techniques work well on microwave systems, but have not been successfully applied to millimeter wave communication systems designed for longer propagation paths (e.g. exceeding a kilometer).

### Modulation Using Phase Shift Keying

Phase shift keying is a digital modulation scheme that conveys information by changing, or modulating, the phase of a reference signal. Usually, each phase encodes an equal number of bits. Each pattern of bits forms a symbol that is represented by the particular phase. A demodulator designed specifically for the symbol-set used by the modulator determines the phase of the received signal and maps it back to the symbol it represents, thus recovering the original data. This requires the receiver to be able to compare the phase of the received signal to a reference signal. Alternatively, instead of using the data bit pattern to set the absolute phase of the wave, it can instead be used to change the phase by a specified amount. The demodulator then determines the change in the phase of the received signal rather than the phase itself. Since this scheme depends on the difference between successive phases, it is termed differential phase-shift keying (DPSK). Differential phase shift keying can be significantly simpler to implement than ordinary phase shift keying since there is no need for the demodulator to have a copy of the reference signal to determine the exact phase of the received signal.

### Costas Loops

A Costas loop is a phase locked loop used for carrier phase recovery from carrier modulation signals, such as from double-sideband suppressed carrier signals. It was invented by in the 1950s. The primary application of Costas loops is in wireless receivers. Its advantage over other similar phase detectors is that at small phase deviations the Costas loop error voltage is larger. This translates to higher sensitivity.

### Last Mile and Middle Mile Communication Services

The United States and many other countries are crisscrossed by many thousands of miles of fiber optic communications links providing almost unlimited communication between major population centers. Telephone companies provide communications services to nearly all of the homes and offices in the United States and many other countries, but existing telephone services in many areas provide only low speed (i.e. low data rate) connections. Communication companies are rapidly improving these last mile services with cable and fiber optic connections, but these improvements are slow and expensive and a large number of people are still without access to high speed communication services. Microwave radios have been used for many years for last mile and middle mile communication services, but bandwidths for these systems are typically limited such that data rates available are typically much less than 1 Gbps. Communication companies are beginning to utilize millimeter wave radios to provide these services but the data rates of most of these radios, although much greater than the microwave systems, are currently limited to about 1 Gbps. Many cellular systems are becoming overloaded due to the increased bandwidth required by the iPhone 4 and similar “smart” phone and other consumer products and prior art backhaul facilities are fast becoming inadequate. Updating these systems is expensive.

### High Data Rate Protocols

A popular communication protocol which is being increasingly utilized to meet this demand for increased bandwidth is the Internet Protocol (IP) 10 GbE Ethernet Standard at 10 Gigabits per second, with a small amount of overhead for ensuring carrier modulation (bit toggling) at some minimum speed. Hereinafter “10 GbE” shall refer to features this 10 GbE Ethernet Standard. There are, however, many current wired and fiber communications standards that use transceivers for serial transfer of binary data at speeds in excess of 4 Gigabits per second. Some of these include: SONET OC-96 (4.976 Gbps); 4×Gig-E (5.00 Gbps); 5×Gig-E (6.25 Gbps); OBSAI RP3-01 (6.144 Gbps); 6×Gig-E (7.50 Gbps); Fibre Channel 8GFC (8.5 Gbps); SONET OC-192 (9.952 Gbps) and Fibre Channel 10 GFC Serial (10.52 Gbps).

### Semiconductor Technology

Recent advances in semiconductor technology have enabled the fabrication of increasingly complex mixed-signal (analog/digital) circuitry on a single integrated circuit chip or a chipset containing a minimal number of chips. Such circuitry has included analog microwave and millimeter-wave front-end amplifiers, filters, oscillators, and mixer/down-converters, as well as intermediate-frequency electronics, phase-lock loops, power control and back-end analog baseband circuitry, along with digital modulators and de-modulators, clock recovery circuits, forward error correction and other digital data management functions. Mixed-signal integrated chip solutions for wireless communications have universally evolved from RF frequencies below 1 GHz (e.g. 900 MHz handsets for wireless telephone in the home) to low microwave frequencies (analog/digital cell phone technology with carrier frequencies up to 2 GHz), to high microwave and low millimeter-wave frequencies (6 to 38 GHz) for wireless point-to-point broadband communications. Most recently, radio receivers and transmitters have been demonstrated using single-chip circuits at frequencies in the license-free band spanning 57 to 64 GHz. These circuits have been based on techniques that have been successfully applied to lower frequency radios. For example, these prior art radio-on-a-chip designs have featured heterodyne and super-heterodyne circuits with relatively narrow (<1 GHz) baseband frequency channels for modulation and demodulation, because the symbol rate was constrained far below 1 billion symbols per second by the channel bandwidth available for microwave radios. A chip refers to a group of integrated circuits on a single substrate and a chipset refers to a set of chips that are designed to work together. Chipsets are usually marketed as a single product.

### Silicon CMOS Technology

Recent advances in semiconductor lithography processes have enabled smaller gate features (<30 nm) in silicon. At these feature sizes, silicon complementary metal-oxide-semiconductor (referred to as “Si CMOS”) technology is capable of reaching cutoff frequencies well in excess of 100 GHz for the first time. While SiGe offers advantages in amplifier noise figure and output power, Si CMOS technology is unparalleled for low cost, and offers the ability to combine high frequency analog front end and conventional digital processing electronics (FPGAs, ADCs, DACs, and DSPs) on a single mixed-signal chip or small set of such chips.

### The Need

What is needed is a millimeter wave radio on a chip or chipset designed appropriately to deal with the added complexities associated with these higher frequencies, and at the same time configured to take advantage of the much higher bandwidth available in the frequency ranges above 70 GHz.

### SUMMARY OF THE INVENTION

### High Data Rate Millimeter Wave Radio on a Chip or Chipset

The present invention provides a high data rate millimeter wave radio transceiver having all or substantially all of its components fabricated on a single chip or a chipset of a small number of semiconductor chips. The chips or chipsets when mass produced are expected to make the price of millimeter wave radios comparable to many of the lower-priced microwave radios available today from low-cost foreign suppliers. Applicants' radios operate in frequency ranges where bandwidths greater than 1 GHz are available, such as the license free range from 57-64 GHz and the licensed range from 71-76 GHz and 81-86 GHz. Some embodiments of the present invention are designed to utilize the entire available bandwidth, greater than 1 GHz, for modulation and demodulation. Optimal designs for Applicants' radio chips will utilize baseband modulation bandwidths of 1 to 5 GHz permitting occupation of up to 5 GHz of contiguous spectrum per half-duplex radio path. Transceivers of the present invention operate at data rates in the range of about 1 Gbps to more than 10 Gbps. The transceiver of a preferred embodiment is designed to receive binary input data at an input data rate in 10.3125 Gbps and to transmit at a transmit data rate in of 10.3125 Gbps utilizing encoded three-bit data symbols on a millimeter carrier wave at a millimeter wave nominal carrier frequency in excess of 50 GHz. The radio uses differential phase-shift keying utilizing eight separate phase shifts. This embodiment of the invention can be used to support many of the high data rate standards including the following group of protocols or standards: SONET OC-96 (4.976 Gbps); 4×Gig-E (5.00 Gbps); 5×Gig-E (6.25 Gbps); OBSAI RP3-01 (6.144 Gbps); 6×Gig-E (7.50 Gbps); Fibre Channel 8GFC (8.5 Gbps); SONET OC-192 (9.952 Gbps); 10 GbE (10.3125 Gbps) and Fibre Channel 10 GFC Serial (10.52 Gbps).

For lowest phase noise, an external oscillator phase-locked to a temperature-controlled crystal is used as the frequency reference for a Si-CMOS-chip-based 10 GbE radio, but all other radio circuit components, including the frequency multiplier chain, up-conversion and down-conversion mixers and millimeter-wave, microwave and baseband amplifiers, data encoder, digital-to-analog converter, vector modulator and demodulator mixers, analog-to-digital convertor, inter-symbol interference filter and all other baseband and digital data and control electronics are implemented using standard CMOS processes on the same silicon substrate or a small number of such substrates. Only peripheral radio components such as fiber-optic transceivers, frequency generators, filters, power supplies and regulators, high-power amplifiers, diplexers and antenna systems are external to the radio chip. A Si CMOS foundry with a 0.028-micron (or smaller) lithography process, such as the TSMC foundry located in Hsinchu, Taiwan, can produce Si CMOS chips of the preferred design for 10 GbE-Band radio transceivers

### First Preferred Embodiment

### A 10 Gigabit Per Second Millimeter Wave Radio

A first preferred embodiment of the present invention includes a 10-gigabits-per-second radio transceiver operating with carrier signals in the frequency ranges of 71-76 GHz and 81-86 GHz. This transceiver includes a transmitter transmitting in the 71-76 GHz band and a receiver receiving in the 81-86 GHz band, or a transmitter transmitting in the 81-86 GHz band and a receiver receiving in the 71-76 GHz band. Two of these transceivers constitute a millimeter-wave radio link designed to operate in accordance with the 10 Gigabit Ethernet standard (which is also referred to as 10 GE, 10 GbE and 10 GigE). In preferred embodiments all of the components of the transceiver are fabricated on a single chip or chipset except the antenna systems, diplexers, delay lines, frequency generators, power amplifiers and voltage regulators.

In this first preferred embodiment the transmitter for each transceiver supports a digital data rate of 10.3125 Gbps (10 Gigabits raw data per second plus IEEE 802.3 Clause 49 64b/66b encoding which accounts for the 0.3125 Gbps excess), using 3-bit symbol encoding (e.g. 8PSK). The carrier phase is modulated at a symbol rate of 3.4375 billion-symbols-per-second, so as to fit easily into the 5 GHz channel modulation bandwidth allowed by the prevailing FCC band plan for E-Band communication. During each (approximately 291 picoseconds) symbol period, 3 bits of data are clocked into a temporary data buffer and then loaded onto three parallel data lines to form a most-significant-bit (MSB), a second-most-significant-bit (2SB) and a least-significant-bit (LSB) in a phase modulator. (A bit is a 1 or 0.) A nearly-instantaneous phase shift is imposed onto the transmitted carrier signal, each shift representing a specific digital symbol. This phase shift comprises one of eight standard phase shifts, with the degree of shift depending on the states of the three data lines. In a preferred embodiment the phase shift is either 0°, 45°, 90°, 135°, 180°, 225°, 270° or 315°. In this preferred embodiment each of these phase shifts respectively represent a symbol consisting of a combination of binary bits, each combination being one of 000 to 111, as shown in the following table:

| | |
|---|---|
| 0° | 000 |
| 45° | 001 |
| 90° | 010 |
| 135° | 011 |
| 180° | 100 |
| 225° | 101 |
| 270° | 110 |
| 315° | 111 |

In the preferred embodiments the receiver in each transceiver includes a demodulator with a sequential state phase comparator that detects and evaluates the received signal to reconstruct the three data bits from each symbol.

The transmitter in this preferred embodiment, designed to operate at 71-76 GHz or 81-86 GHz, includes a frequency stabilized millimeter wave source operating at the millimeter wave carrier frequency (preferably centered at 73.5 GHz or 83.5 GHz; an encoder having an output clocked at the on-off keyed input data rate divided by three and adapted to generate sets of four phase shift modulator control bits, each set representing one of eight three-bit symbols; and a modulator adapted to apply each set of four phase shift modulator control bits from the output of the encoder to the millimeter carrier wave in the form of a single phase shift for each three-bit symbol, each phase shift being one of eight standard, recognizably distinct phase shifts. The receiver is adapted to receive an incoming millimeter wave signal transmitted from a remote millimeter wave transmitter transmitting at frequencies in excess of 70 GHz and to reconstruct communications data sent from the remote transmitter. The receiver of this preferred embodiment includes a millimeter wave amplifier adapted to amplify the incoming millimeter wave signal and a demodulator adapted to decode the incoming millimeter wave signal to produce a binary output data stream at an output data rate of 10.3125 Gbps.

### Second Preferred Embodiment

### An Improved 10 Gigabit Per Second Millimeter Wave Radio

This application includes a second preferred embodiment of the present invention which includes some significant improvements over the first preferred embodiment. Important differences are described below:

Gray Coding

Version 1 of the radio does not use Gray encoding of the data signal, but uses a standard binary progression of three-bit words as the 8PSK constellation is traced counter-clockwise around the complex (I/Q) plane. When data belonging to a given symbol state (constellation point) is erroneously interpreted as belonging to an adjacent state, any number of bit errors can result; for instance a 135° phase jump, which might be encoded as a ‘011’, could be mistaken for a 180° phase jump, which could be encoded as a ‘100’. In this case all three bits in the word would be in error.

Version 2 of the radio uses Gray coding, which forces data words corresponding to adjacent points on the constellation to differ by only a single bit. For this version, the 135° phase jump might represent the three bits ‘010’, while the 180° phase jump could represent ‘110’. An error in interpretation between these two states thus results in only a single bit error, delivering a three-fold improvement in bit-error performance relative to the no-encoding example in the previous embodiment.

Transmitter Vector Signal Modulator

Version 1 of the radio generates 8 phase states separated by 45° intervals, by combining the outputs of a pair of I/Q mixers driven at a 45° phase offset, with each mixer driven by binary (+1/−1) phase controls on both the in-phase (I) and quadrature phase (Q) channels.

Version 2 of the radio generates the same 8 phase states using a single I/Q mixer, in conjunction with a pair of fast digital-to-analog converters (DACs) used to drive each of the I and Q channels to one of five discrete (+1/+0.71/0/−0.71/−1) amplitude states.

Transmitter Signal Modulator Driver

Version 1 of the radio uses an analog signal modulator driver in which the binary phase controls for each of the two I channels and two Q channels are derived directly from the last six bits in the data stream through Boolean logic and a small number of fast gate circuits.

Version 2 of the radio uses a digital signal modulator driver comprised of a fast Field-Programmable Gate Array (FPGA) with an algorithm that compares the last six bits of the data stream to a Gray-encoded differential phase look-up-table (LUT) to deliver digital control values to the fast DACs driving the vector signal modulator.

Carrier Recovery

Radio Version 1 uses a Costas Loop to phase lock the receiver down-converter local oscillator to the transmitted carrier, recovering the carrier phase and frequency such that the received constellation is stable (doesn't spin around). Costas loops for 8PSK use a large number of high frequency components that need to be amplitude and phase matched, and can be difficult to keep stable over temperature.

Radio Version 2 uses a frequency generation scheme whereby the transmitted carrier frequency is derived from the same frequency reference as the transmitted data clock. The data clock can be recovered accurately with an edge detector in the receiver, and using the same known multiply and divide ratios as those utilized in the remote transmitter, the transmitter carrier can be reconstructed from the data clock (to within a constant offset phase, which is rendered irrelevant by differential 8PSK [D8PSK] modulation). This eliminates the need for the Costas loop altogether, and provides improved stability.

Receiver Signal Demodulator

Version 1 of the radio uses an analog signal demodulator, in which the three-bit data stream corresponding to a detected signal phase shift is determined directly by mixing the previous two symbols together using a one-symbol-period delay line and an array of phase shifters to generate a set of four analog control voltages. A combination of analog summing, differencing, squaring and thresholding circuits then converts these control voltages directly into a series of three binary states that represent the values of the latest three data bits in the data stream.

Version 2 of the radio uses a digital signal demodulator, comprised of a pair of fast digitizers and an I/Q mixer, to determine the vector amplitudes of the transmitted in-phase and quadrature signals. The phase change between symbols is inferred (in the FPGA) from changes in the calculated I- to Q-channel amplitude ratio, and an LUT on the FPGA is used to Gray-decode and convert the inferred phase change to a three-bit data stream.

Inter-Symbol Interference Equalization

Version 1 of the radio has no form of Inter-Symbol Interference (ISI) equalization, which leads to degrading bit-error performance as the modulated signal bandwidth approaches the maximum channel bandwidth allowed by the FCC. In order to minimize bit error performance, this radio requires extremely flat amplifier gain and constant filter group delay across the full modulated signal bandwidth.

Version 2 of the radio incorporates a Finite-Impulse-Response (FIR) filter pre-programmed into the FPGA to compensate the received signal for any distortion caused by the band limiting of the transmitted signal. This filter convolves a FIR transfer function, developed through prior training of the receiver against known transmission patterns, across the digitized signal waveform to clean up distortion prior to data decoding in the FPGA. This improves radio bit-error performance relative to the radio without ISI equalization, and relaxes the requirements for extremely flat amplifier gain and constant filter group delay across the modulated signal bandwidth.

### Other Preferred Embodiments

Other preferred embodiments include two-transceiver E-Band radio links, with D8PSK modulation and demodulation, capable of 10.3125 Gbps operation. Each of these links includes a first transceiver designed to transmit at a first E-Band frequency band and to receive at a second E-Band frequency band, each of the two bandwidths, defining a first and second E-Band bandwidth, being at least as wide as 3.5 GHz. Preferably the bandwidths are the full 5 GHz as allowed for E-Band radios at 71-76 GHz ant 81-86 GHz in the United States.

### The First Transceiver

Front End Circuitry

The first transceiver includes front-end circuitry, all of which or mostly all of which is fabricated on a single chip or chipset. The front end circuitry receives a binary input data stream and is designed with a capability of producing output signals at data rates at least as fast as 10.3125 Gbps utilizing D8PSK modulation of an E-Band carrier signal with the transmitter front-end circuitry comprising: encoding circuitry adapted to encode input binary signals to produce encoded signals, with each encoded signal comprising three bits; and D8PSK modulation circuitry adapted to phase shift the millimeter wave carrier signal based on the encoded signals to produce a phase-shifted carrier signal at the first E-Band frequency band with each phase of the signal defining one of eight phases, having spacing between the phases of about 45 degrees or a multiple of about 45 degrees.

Receiver Circuitry

The first transceiver includes receiver circuitry, all of which or mostly all of which are fabricated on a single chip or chipset, adapted to receive incoming E-Band signals transmitted from the second transceiver at the second E-Band frequency millimeter wave transmitter. This receiver circuitry will preferably include: millimeter wave amplifier circuitry adapted to amplify incoming E-Band signals and demodulation circuitry adapted to demodulate the amplified incoming millimeter wave signals to produce a binary output data stream.

Radio Transmit and Receive Components

The first transceiver also includes radio transmit and receive components for transmitting and receiving phase-shifted E-band radio signals to and from the second transceiver. These radio components comprise: millimeter wave amplifier circuitry for amplifying the phase shifted carrier signal to produce an amplified phase shifted transmit E-Band radio beam and millimeter wave amplifier circuitry adapted to amplify phase-shifted carrier signals received from the second transceiver.

Antenna System

The first transceiver will need an antenna system adapted to convert the phase shifted E-band radio transmit beams to produce a narrow band E-Band “pencil beam” confined within a single narrow channel less than 1.2 degrees wide and to collect phase shifted E-band radio beams transmitted from the second transceiver.

### The Second Transceiver

Millimeter wave radio links of the present invention includes a second transceiver substantially similar to the first transceiver to communicate with the first transceiver except the second transceiver has components designed to transmit at the receive frequency band of the first transceiver and to receive at the transmit frequency band of the first transceiver.

In preferred embodiments the transmitter front-end circuitry of both transceivers are adapted to derive their internal clock references directly from 10 GbE fiber or coaxial cable data input, and to generate symbol clock, intermediate frequencies and transmit frequencies from their internal clock references. In these preferred embodiments both transceivers derive their receiver symbol clock from their 10 GbE antenna data input, with the result that the receiver internal symbol clock of each of the transceivers is slaved to the transmitter clock of the other transceiver and is fully independent of internal transmit clock of the transceiver. Also, the receiver circuitry of each of the two transceivers utilizes an edge detector comprised of a delay and sum interference circuit, using a half wave delay of the intermediate frequency receive signal to detect and synchronize to phase jumps and to generate its symbol clock, intermediate frequencies and local oscillator frequencies from its internal receive clock, thus eliminating the need for a Costas loop or other carrier recovery circuit. In addition, receiver circuitry of each of the two transceivers is adapted to decode data based on differential phase between successive symbols, eliminating a need for a common phase reference with the transmitter of the other transceiver.

In some embodiment the chips or chipsets are comprised of silicon germanium, but a preferred embodiment may utilize silicon complementary metal-oxide semiconductor (Si CMOS) technology for greatly reducing the cost of the radio links. In most embodiments peripheral radio components are needed external to the chips or chipsets. These include some or all of the following components: fiber-optic transceivers, frequency generators, filters, power supplies and regulators, high-power amplifiers, diplexers and antenna systems. Amplifies, clock recovery, mixers, frequency multiplies and dividers, edge detectors, and phase comparators, and digital processing electronics, including digitizers, FPGA's, digital to analog converters, are preferably fabricated on a single all-silicon CMOS semiconductor chips or chipsets. 17. Transmitters and the receivers may transmit and receive through separate antennas or through common antennas. Transmitters may be adapted to provide a dynamic range in power output exceeding 15 dB. The transmitter and the receiver portions of the transceivers may be contained in a single enclosure or separate enclosures.

### Other Embodiments

Other embodiments of the present invention include millimeter wave radios operating at data rates lower than about 10 Gbps. For radios operating at data rates much lower than about 10 Gbps, other modulation schemes may be preferred. For example, for data rates between about 1.25 Gbps to about 3.5 Gbps a Differential Binary Phase Shift Keying (DBPSK) modulation scheme is preferred. For data rates between about 3.5 GBPS to about 7 Gbps a Differential Quadrature Phase Shift Keying (DQPSK) modulation scheme is preferred.

In preferred embodiments operating at data rates in the range of about 3.5 Gbps the occupied transmit bandwidth is preferably between 1.0 GHz and 5 GHz. For data rates of the 10 GigE transceiver the occupied transmit bandwidth is preferably between 3.5 GHz and 5 GHz. Preferably the power spectrum density within more than 70 percent of the output power of the transmitter is constant to within +/−1.5 dB and the transceiver provides provide a dynamic range in power output exceeding 15 dB.

### BRIEF DESCRIPTION OF THE DRAWINGS

FIGS. 1A and 1B show features to two radios for a preferred embodiment of a 10.3125 Gbps millimeter radio link.

FIGS. 2A and 2B are drawings showing features of a modulator for a first preferred embodiment of the present invention.

FIG. 3 shows important components of a D8PSK state adder.

FIG. 4 describes drive logic for a preferred embodiment of the present invention.

FIG. 5 is a state table applicable to a preferred embodiment.

FIG. 6 is a demodulator circuit for preferred embodiments.

FIG. 6A shows features of an 8PSK Costas loop for stabilizing the FIG. 6 circuit.

FIG. 7 is a drawing from the parent application showing features of the radios described therein.

FIGS. 8A and 8B show features of an embodiment where the 45 degree delay line 350 that is shown in FIG. 1A is omitted.

FIG. 9 describes the transmitter of a second preferred embodiment.

FIG. 10 shows how data is handled by a fast FPGA and clocked into an array processor at a slower rate.

FIG. 11 shows a symbol “constellation” of the second preferred embodiment.

FIG. 12 demonstrates the use of a high quality temperature controlled crystal oscillator (TCXO) to suppress phase noise.

FIG. 13 shows the use of digital to analog device to drive X and Y magnitudes for the symbol constellation.

FIG. 14 shows a clock and data recovery circuit.

FIG. 15 shows features of a receiver for detecting and demodulating the transmit signal.

FIG. 16 shows how the transmitter provides the clock for both the transmitter and the receiver.

FIG. 17 shows how the clock signal is used to control the ultra-stable TCXO.

FIG. 18 shows how the signal from the transmitter is filtered and how phase is compared to the previous phase to determine the size of the phase jump.

### DETAILED DESCRIPTION OF PREFERRED EMBODIMENTS

### Circuit Methodologies

As radio technology has evolved from low frequencies to higher and higher frequencies, the circuit methodologies optimized for the physical and practical constraints of lower-frequency communications were continually applied to higher frequency applications. This was done without consideration for differences in the physical and practical constraints characteristic of high frequency communications. As a result, previous attempts at delivering single-chip and minimal chipset solutions for frequencies above 64 GHz have not been successful at producing commercially viable radios.

Two key conditions dictated early (lower frequency) chip designs for fixed point-to-point communications: 1) very limited available bandwidth in which to transmit as much data as possible, and 2) minimal dynamic range variation associated with rain fade and other weather or atmospheric variations. The first of these conditions dictated the adoption of very high-order modulation techniques such as 64-CAM, 128-CAM, or 256-QAM, in which several (6 to 8) digital bits could be sent simultaneously using a single pseudo-digital symbol, thereby increasing spectral throughput (bits per second per Hertz). The high-order modulation results in a penalty of 17 to 22 dB in transmitter power relative to single-bit symbol modulation (on-off keying or binary phase shift keying) to maintain a manageable bit error rate. The second key condition, the comparatively lower atmospheric attenuation and weather fade characteristic of lower frequencies, made such modulation efficiency trades desirable for microwave radios, by requiring little additional signal to noise link margin to cope with high humidity and heavy rainfall.

### Silicon-Germanium Semiconductors

Silicon-germanium bipolar transistors on complementary metal-oxide-semiconductor (referred to as “SiGe BiCMOS”) technology, which marries the superior low-noise and high-speed properties of the SiGe heterojunction bipolar transistors with the low cost and manufacturability advantages of conventional CMOS technology, represent an ideal solution for mixed-signal applications such as millimeter-wave wireless communications systems, in which frequency sources and multipliers, mixers and low-noise amplifiers are used alongside digital modulator control and processing circuitry. Amplifiers using SiGe bipolar transistors are more efficient and achieve lower noise figures than comparable conventional CMOS amplifiers, and the higher breakdown voltage of SiGe allows for higher device output power as well.

### High Frequency Radio Components on Si and SiGe

Gallium Arsenide (GaAs) is superior to SiGe semiconductors for ultra-low phase noise high-frequency oscillators (so an external microwave phase-locked voltage-controlled oscillator (PLVCO) is a preferred frequency source), but the frequency multiplier chain, up-conversion and down-conversion mixers and millimeter-wave, microwave and baseband amplifiers can all be implemented satisfactorily using conventional microstrip circuitry on Si and SiGe semiconductor substrates. For lowest cost, a silicon wafer can be used as a substrate, with germanium placed locally on the chip at the locations of the millimeter-wave transistors and diodes, so that the SiGe material is localized only in the regions of the high-frequency MMW and microwave semiconductor junctions. Lower frequency circuitry, including the data encoder, high-speed driving logic and all other baseband and digital data and control electronics are implemented using standard CMOS processes on the same silicon substrate. The data decoder and delay-stabilizing Costas loop can be implemented on the receiver chip, but due to its physical size the longer symbol-period delay line is best implemented off-chip, using a microstrip line on a flex-circuit material such as Rogers 3003 or using a waveguide delay line. A SiGe foundry, such as the Global Foundries foundry located near Essex Junction, Vt., with a 0.13-micron or 0.09-micron SiGe process can produce SiGe chips of the preferred design for 10 Gbps E-Band radio transceivers.

### Chip Design

Prior radio-on-a-chip designs have universally featured heterodyne and super-heterodyne circuits with relatively narrow (<1 GHz) baseband frequency channels for modulation and demodulation, because the symbol rate was constrained far below 1 billion symbols per second by the channel bandwidth available for microwave radios. Optimal designs for E-Band radio chips will utilize baseband modulation bandwidths of 1 to 5 GHz to make use of the preferential E-Band rules allowing occupation of up to 5 GHz of contiguous spectrum per half-duplex radio path.

### First Preferred Embodiment

### Applicants' First Preferred 10-GigE Radio

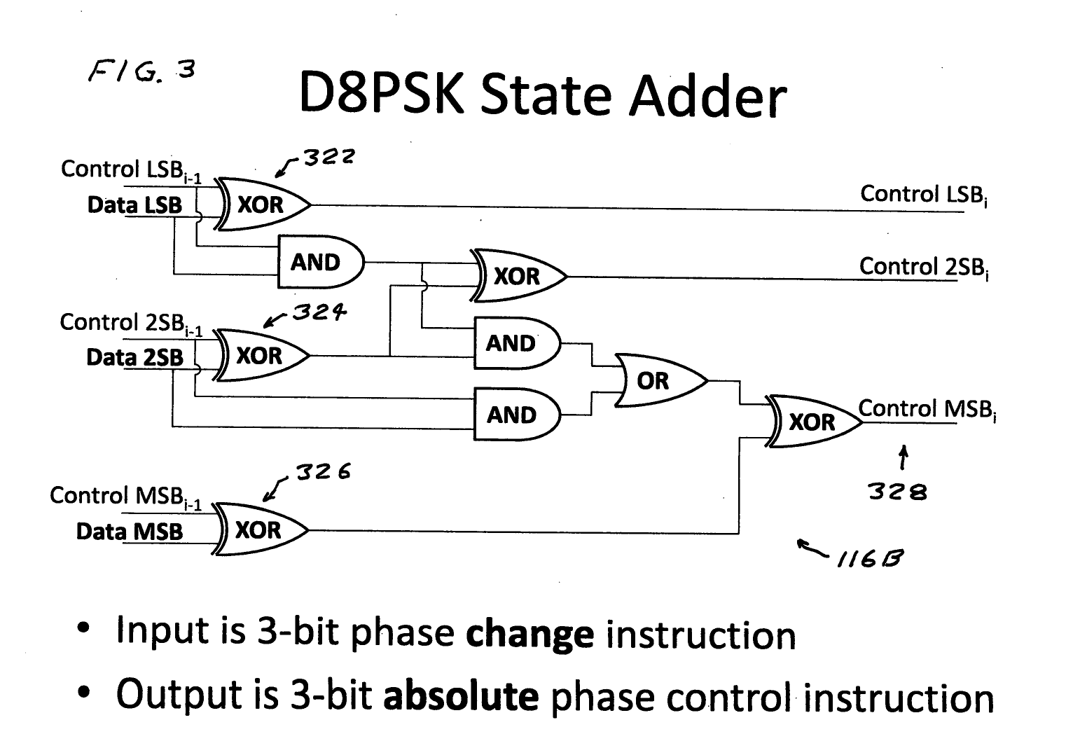

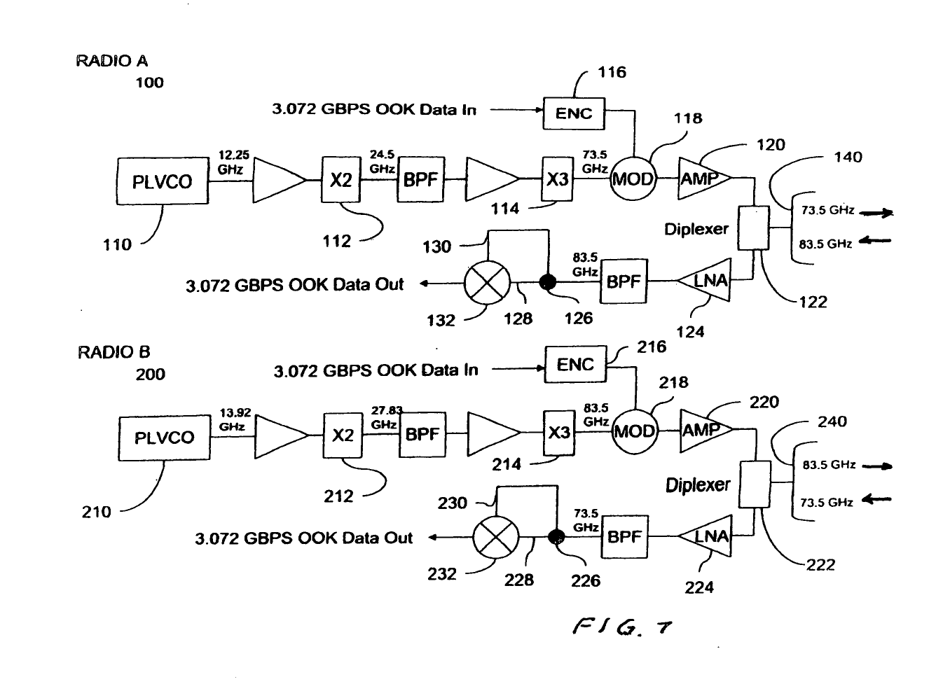

A first preferred embodiment of the present invention satisfying the needs outlined above is a 10-GigE radio. The radio is based on and is a substantial improvement of the basic circuit design of a 3.072 Gbps radio described in parent patent application Ser. No. 12/928,017 (now U.S. Pat. No. 9,008,212) which is the parent of Ser. No. 12/228,114 filed Aug. 7, 2008 which is the parent of Ser. No. 12/930,947 filed Jan. 29, 2011 which is the parent of this application. This radio utilized radio circuitry as specifically described in FIG. 3 of the above patent which is reproduced in this application as FIG. 7.

To support a digital data rate of 10.3125 Gbps (10 Gigabits raw data per second plus IEEE 802.3 Clause 49 64b/66b encoding which accounts for the excess 0.3125 Gbps), the radio uses 3-bit symbol encoding and has its carrier modulated at a symbol rate of 3.4375 Giga-symbols-per-second so as to fit into the 5 GHz channel modulation bandwidth allowed by the prevailing FCC band plan for E-Band communication. The product of the 3.4375 billion symbols per second and the 3 bits per symbol results in the above digital data rate of 10.3125 billion bits per second.

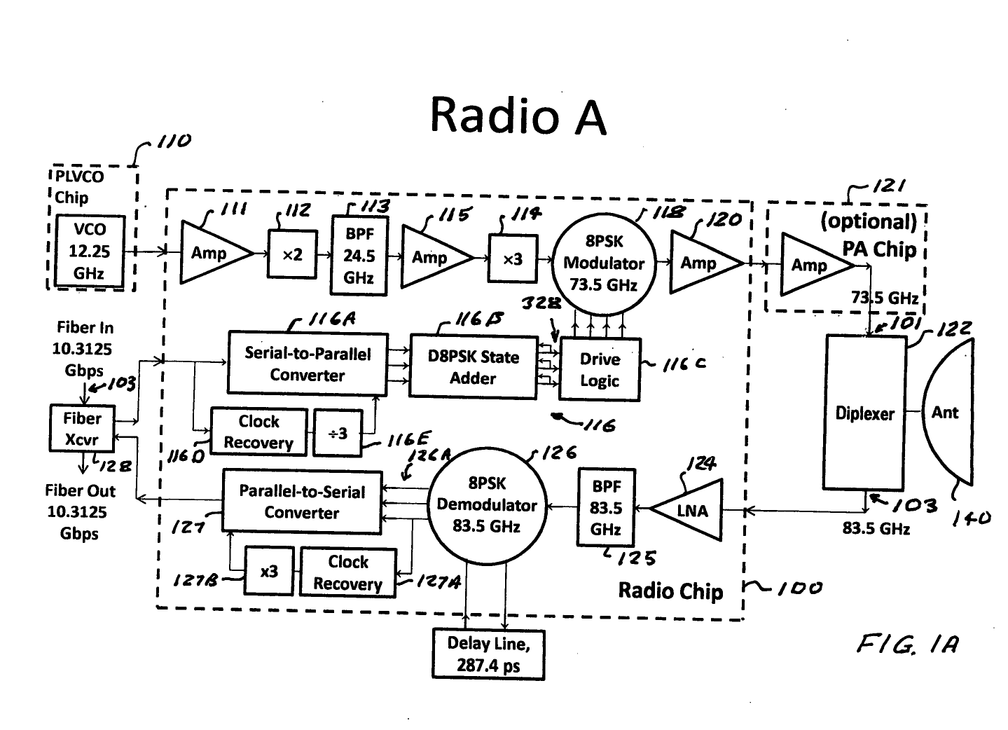

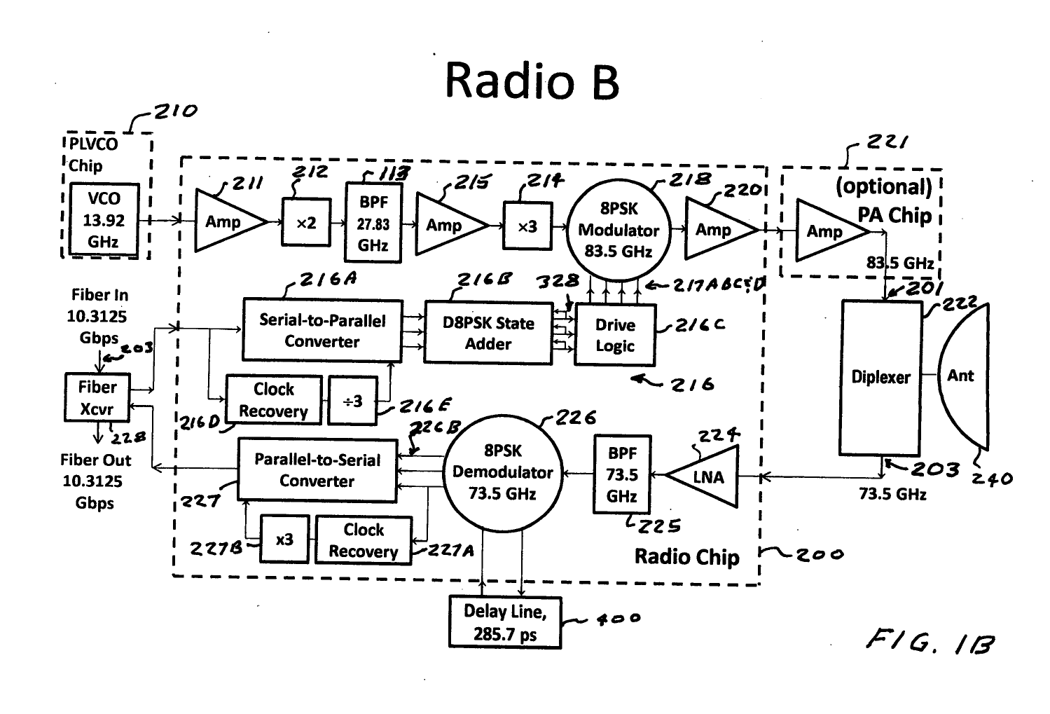

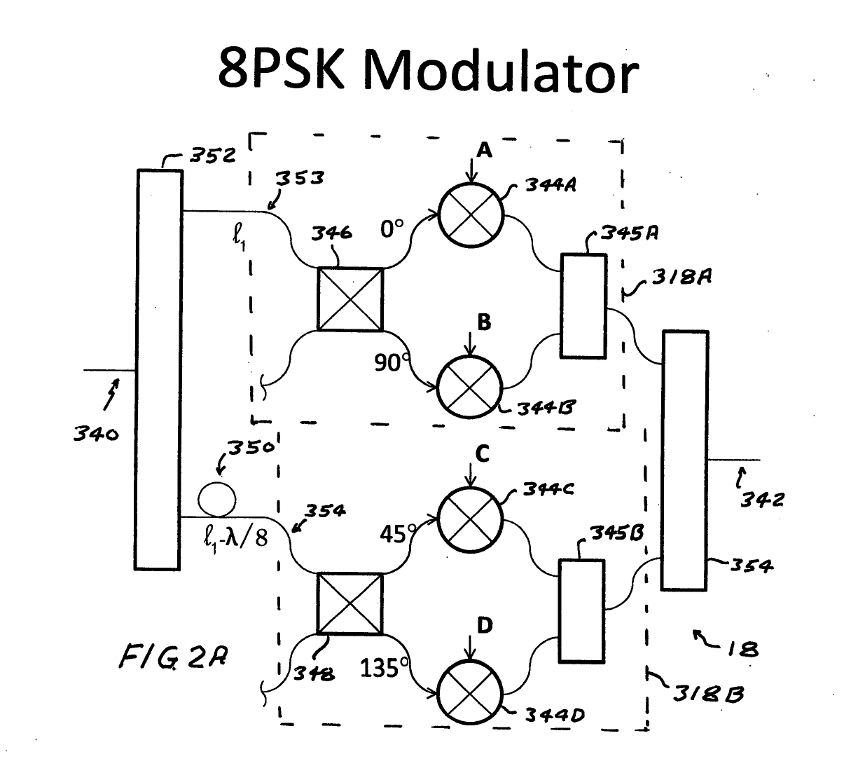

In preferred embodiments the millimeter wave chipset radios are marketed as a pair of radios making a 10-GigE millimeter radio link supporting nominal data rates of about 10 Gbps. Details showing the important electronic components are described by reference to FIGS. 1A and 1B. One of the radios, Radio A, transmits at an average frequency of 73.5 GHz with a permitted total bandwidth of 5 GHz and receives at an average frequency of 83.5 GHz, and the other radio, Radio B, transmits at an average frequency of 83.5 GHz with a permitted total bandwidth of 5 GHz and receives at an average frequency of 73.5 GHz. Components of Radio A are identified with reference numbers between 100 and 140 and components of Radio B are identified with reference numbers between 200 and 240. Most of the components of each radio are fabricated on a single semiconductor substrate to provide radio chip 100 for Radio A and radio chip 200 for Radio B.

### Transmitter Circuits

As shown at 103 and 203 in FIGS. 1A and 1B input to the radios is a fiber optical signal at 10.3125 Gbps. These signals are converted from on-off optical to on-off electrical in fiber converter 128 and 228. The output on-off electrical signal at 10.3125 Gbps is directed to encoder circuitry 116 and 216 which utilizes this electrical signal to produce drive signals to modulate 73.5 GHz and 83.5 GHz signals generated in the transmitter portion of the radio transmitter circuitry. The encoder circuitry is described in detail in a following section.

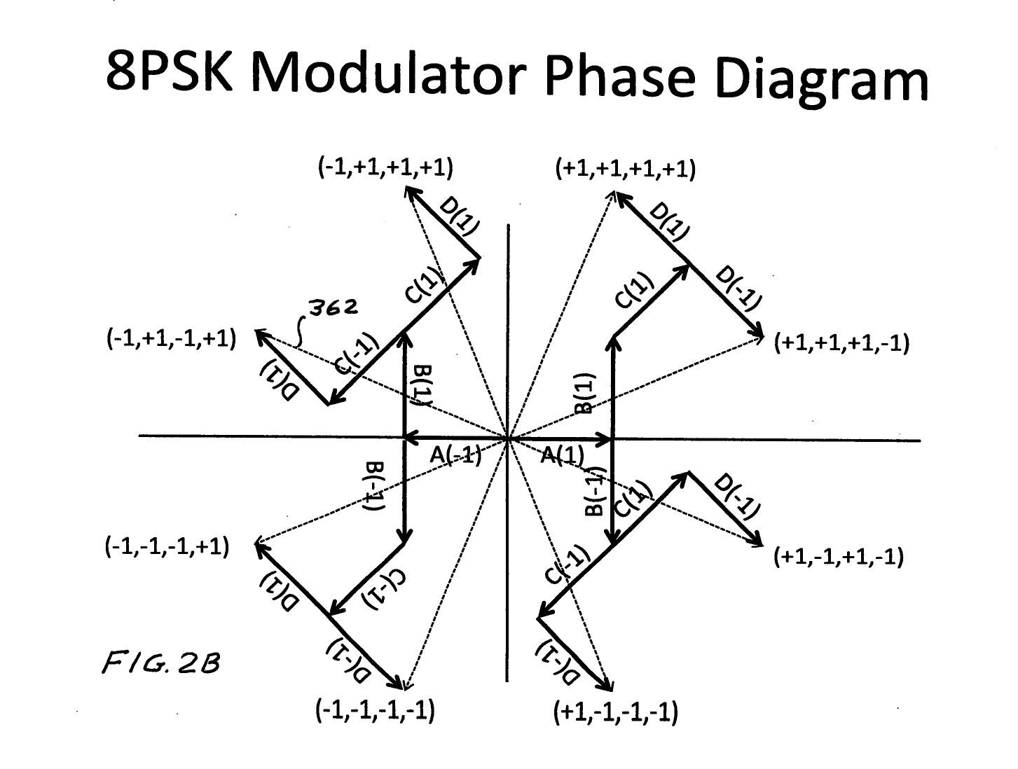

As shown in FIGS. 1A and 1B a microwave signal is generated off chip, using phase-locked voltage controlled oscillators 110 and 210, chosen for very low phase noise. These oscillators, such as Hittite Part Number HMC783 and Part Number HMC807, are locked (at 12.25 GHz for Radio A and 13.92 GHz for Radio B respectively) to a crystal reference. These microwave signals are amplified in on-chip amplifiers 111 and 211, frequency doubled to 24.5 GHz and 27.83 GHz (in multipliers 112 and 212) filtered in filters 113 and 213, amplified in amplifiers 115 and 215, and then frequency tripled in times-three frequency multipliers 114 and 214 (to frequencies of 73.5 GHz and 83.5 GHz respectively), to produce carrier frequencies preferably approximately centered in the 71-76 band (73.5 GHz for Radio A) and 81-86 GHz band (83.5 GHz for Radio B), with resulting integrated RF phase noise of less 5 degrees. This signal passes to the phase-shift keyed modulators 118 and 218 and on to a power amplifier 120 and 220, for output to the antenna diplexer 122 for Radio A and diplexer 222 for Radio B. Key improvements over the radio of the parent application and the earlier prior art is encompassed in modulators 118 and 218 and are described below with reference to FIG. 2A through 2C.

The transmitter power amplifier 120 and 220 includes at least 15 dB of power adjustment by way of a control voltage to the transmitter power amplifiers 120 and 220, designed to compensate for rain fade by way of an in-band or out-of-band handshake communication of power margin with a remote receiver. The full amplifier chain is designed to provide less than 3 dB of gain variation across the full (approximately 4 GHz) operating bandwidth of the transmitter. The power amplifiers 120 and 220 are designed for high efficiency and their saturation power will not typically exceed 200 milliwatts. Any requirement for higher output power can be accommodated by a separate external amplifier 121 and 221 between the transceiver chip and the diplexer.

### Modulation of the Transmit Carrier Signal

### D8PSK Modulator

Important components of modulators 118 and 218 are shown at 18 in FIG. 2A for a preferred modulator design. This modulator supports a digital data rate of 10.3125 Gbps (10 Gigabits raw data per second plus IEEE 802.3 Clause 49 64b/66b encoding), using 3-bit symbol encoding (e.g. 8PSK) to modulate the carrier signals at a symbol rate of 3.4375 Giga-symbols-per-second (so as to fit into the 5 GHz channel modulation bandwidth allowed by the prevailing FCC band plan for E-Band radios). Modulator 18 includes input signal splitter 352, output signal combiner 354, 45-degree phase delay line 350, and two IQ modulators circuits 318A and 318B. The IQ modulator circuits are similar to those in Goteborg Microwave Integrated Circuits model MDR080A01, incorporate 90-degree hybrid splitters 346 and 348, phase conserving/inverting mixers 344A, 344B, 344C and 344D, and combiners 345A and 345B. Splitter 352 divides the input signal into two equal signals a reference signal in line 353 and a second signal in line 354. The signal in line 354 is phase shifted by 45 degrees by delay line 350. In IQ modulator 318B this signal is then split through 90-degree hybrid 348 into two parts which are phase shifted respectively by a total of 45 degrees and 135 degrees relative to the initial reference signal, and these signals are passed through two driver-controlled switchable phase inverters before being recombined at 345B. In IQ modulator 318A, the reference signal is split into two parts by 90-degree hybrid 346, one part of which is not phase shifted and the other part of which is phase shifted 90 degrees, and then passed through two driver-controlled switchable phase inverters before being recombined at 345A. The signals from IQ modulator circuits 318A and 318B are then further combined in combiner 354 to form an 8PSK-modulated waveform.

In this preferred embodiment modulator 18 (referring to modulators 118 and 218) is controlled to shift the phase of the carrier signal (either 73.5 GHz or 83.5 GHz) at approximately 291 ps intervals (a rate of 3.4375 billion shifts per second) by four phase control bits 217A, B, C and D generated in encoder circuitry shown at 116 and 216 (A through E) in FIGS. 1A and 1B. The amount of shift is one of the following: 0°, 45°, 90°, 135°, 180°, 225°, 270° or 315°. The carrier signal enters modulator 18 as shown at 340 in FIG. 2A with an incoming phase and exits the modulator as shown at 342 with an exit phase. The shifts are imposed on the 73.5 GHz or 83.5 GHz carrier signal with the 8PSK modulator shown in FIG. 2A using drive signals A, B, C and D as shown in FIG. 2A. The logic state of each of drivers is either +1 or −1; the preferred IQ modulators use differential line pairs to deliver these drive states to the mixers. Simple drivers at A, B, C, and D output signals with positive polarity, which causes the mixers 344A, 344B, 344C and 344D to preserve signal polarity, or signals with negative polarity, causing the mixers to invert signal polarity.

### Encoders

FIGS. 3, 4 and 5 explains how phase control bits are encoded in encoders 116 and 216 (shown in FIGS. 1A and 1B) onto the 73.5 GHz and the 83.5 GHz carrier signals once each 291 ps, in the form of a single phase shift selected from one of the eight recognizably distinct phases listed in the State Table in FIG. 5. In the encoders, data are clocked by clock recovery circuits 116D and 216D and clock divider circuits 116E and 216E reducing the clock rate by a factor of three. The digital signal at the 10-Gigabit-Ethernet rate of 10.3125 Gbps is fed into a 3-bit temporary buffer, and then transferred simultaneously to a D8PSK state adder circuit 116B and 216B as a three-bit symbol at 3.4375 (equal to 10.3125 divided by 3) billion symbols per second onto three parallel data lines, identified as a most-significant bit (Data MSB), second-most-significant bit (Data 2SB), and least-significant bit (Data LSB). FIG. 3 describes the D8PSK state adder circuits. There the signals are used to compute a three-bit control word to feed the drive logic circuits which in turn drives the D8PSK modulators 118 and 218 as shown in FIGS. 1A and 1B and FIG. 2A.

Phase control bits are generated using a summing circuit in each of encoders 116 and 216 shown in FIGS. 1A and 1B. Each of these summing circuits is referred to as D8PSK state adder circuits as is shown in FIG. 3. This summing circuit is used to generate eight phase shift keyed modulator control bits from the 10-GigE data stream 103 and 203 received by the receive encoders 116 and 216 as shown in FIGS. 1A and 1B. In this summing circuit the current data least significant bit (Data LSBᵢ₋₁) is added to the control least significant bit (Control LSB) from the prior (291 ps earlier) symbol of three bits, as shown at 322 in FIG. 3. The same is done for the second significant bit and the most significant bit as shown at 324 and 326 utilizing XOR, AND, and OR logic circuits, also as shown in FIG. 3. The carry bit from the sum of the most significant bits is truncated. The result is the creation of current Control LSBᵢ, Control 2SBᵢ and Control MSBᵢ as shown at 328 in FIG. 3 and FIGS. 1A and 1B. Thus, the input to the summing circuit is the three-bit phase change instruction data as shown in FIG. 3 and the output is the three-bit absolute phase control instruction.

### Drive Logic

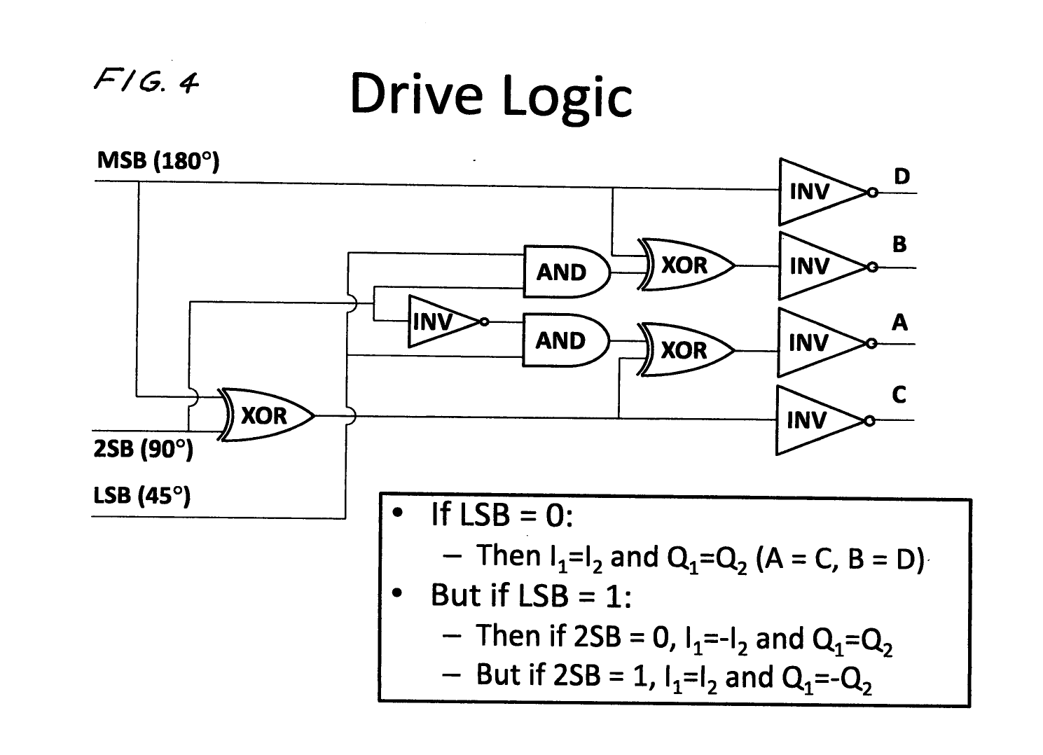

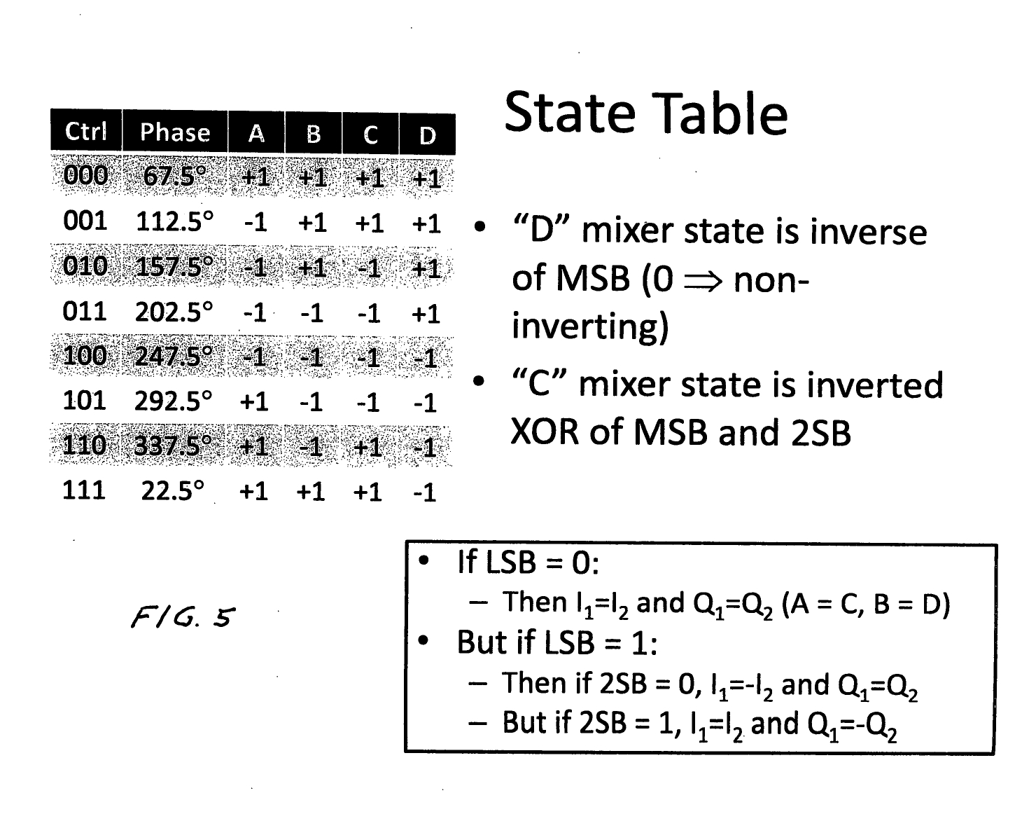

The State Table in FIG. 5 provides eight phase control bit patterns, 000, 001, 010, 011, 100, 101, 110 and 111, and eight sets of corresponding modulator inputs for each of the four modulator drive signals, A, B, C and D, for the 8PSK transmitter modulator 18 shown in detail in FIG. 2A. As described previously, the phase control bits shown in the State Table do not represent the data stream itself, but rather the sum of the three current data bits added to the prior phase control bits and truncated to the three least significant bits and discarding any fourth bit. As such the transmitted data is encoded into the phase shift rather than the phase, so that no absolute phase calibration is necessary at the remote receiver. The IQ modulator inputs A, B, C, and D are encoded by drive logic circuitry 116C and 216C as shown in FIGS. 1A and 1B. These circuits use XOR, AND, and inverter logic circuits as shown in FIG. 4. The 8PSK modulator drive logic generates drive signals A, B, C and D for the IQ modulators 218A and 318B shown in FIG. 2A. The drive signals are according to the phase encoding plan shown in the State Table in FIG. 5. Simple drivers at the output generate positive polarity, causing the mixers 344A, B, C and D to preserve signal polarity, for a logic state of +1 as shown in the State Table in FIG. 5, or generate negative polarity, causing the mixers to invert signal polarity for a logic state of zero (represented by −1 in the State Table FIG. 5).

### 8PSK Modulator Phase Diagram

As explained above and as shown in FIG. 2A signals entering phase conserving/inverting mixers 344A, 344B, 344C and 344D are offset relative to each other; i.e. the signal entering mixer 344A is 0 degrees, 344B is 90 degrees, 344C is 45 degrees and 344D is 135 degrees. So, for example, to transmit a three-bit symbol representing the three-bit symbol 010, modulator 18 would impose a phase shift of 157.5 degrees as shown at 360 in FIG. 5. As shown in the State Table of FIG. 5 this calls for an A drive signal of −1, a B drive signal of +1, a C drive signal of −1 and a D drive signal of +1. The −1 A-Drive signal causes inverter 344A to switch its 0 degree signal to 180 degrees; the +1 B-Drive signal causes inverter 344B to retain its 90 degree signal; the −1 C-Drive signal causes inverter 344C to switch its 45 degree (45 degrees plus 0 degrees) signal to 225 degrees and the +1 D Drive signal causes inverter 344D to retain its 135 degree (45 degrees plus 90 degrees) signal at 135 degrees. The net effect is a net shift of 157.5 degrees as shown by the dashed vector line 362 on the 8PSK Modulation Phase Diagram shown in FIG. 2B.

As explained above the millimeter wave signals exiting modulators 118 and 218 are amplified in amplifier 120 and 220 respectively and may be further amplified in an off chip amplifier 121 and 221. The amplified electrical signal is then directed to diplexer 122 and 222 where it is directed to antenna 140 and 240 where the amplified electrical is converted to a millimeter wave signal for transmission to the receiving transceiver at the other end of the radio link.

### Receiver Circuits

The principal receiver circuits for Radio A and Radio B are shown in FIGS. 1A and 1B. Incoming millimeter wave signals at nominal frequencies of 73.5 GHz or 83.5 GHz are collected in antennas 140 and 240, separated in diplexer 122 and 222, amplified in low noise amplifier 124 and 224, filtered in band pass filter 125 and 225 to filter out out-of-band noise, and demodulated in demodulator 126 and 226 where they may drive a fiber-optic transmitter or other transmission medium to produce a 10.3125 Gbps on-off data output stream via a clock recovery circuit and a parallel-serial converter as shown at 105 and 205 in FIGS. 1A and 1B.

### D8PSK Demodulator

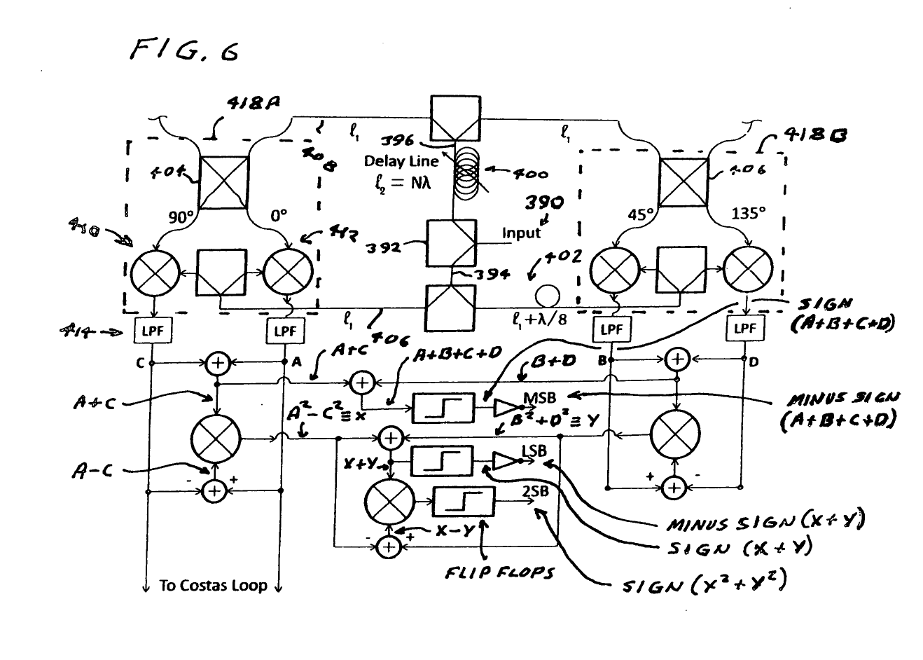

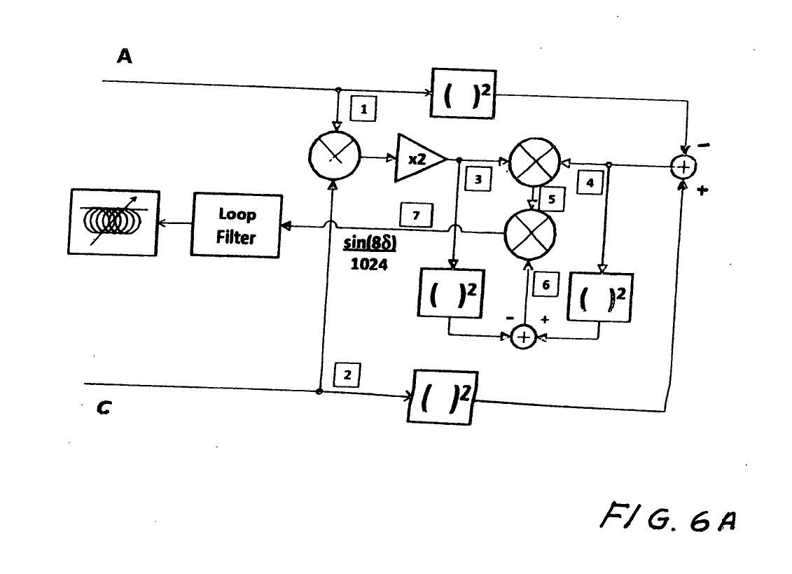

Details of the demodulation circuits 126 and 226 are described in FIGS. 6 and 7. In these circuits the differential 8-state phase shift is detected and evaluated using a sequential state phase comparator, to reconstruct the most, second and least significant bits, MSB, 2SB, and LSB of each of the three-bit symbols at the rate of 3.4375 Gbps. As shown in FIG. 6, off-chip delay line 400 corresponding to an integral number of carrier wavelengths, matching as closely as possible the total phase change across one symbol period (291 ps), and a 45 degree delay line and a pair of 90 degree hybrids are used to compare the phase state of the current data symbol with the previous data symbol.

The current signal is input as shown at 390 and split in splitter 392 into a current state signal 394 and a previous state signal 396. One-half of the input signal 390 is directed through the delay line 400 (delay time matching integral wave periods closest to one 291 ps symbol period; i.e. 285.7 ps [exactly 21 periods] for a 73.5 GHz demodulator, and 287.4 ps [exactly 24 periods] for a 83.5 GHz demodulator) to create the previous signal 396. A second λ/8 (corresponding to 45 degrees) delay line 402 (this one is preferably on-chip) and a pair of IQ modulator circuits 418A and 418B (similar to circuits of Göteborg Microwave Integrated Circuits model MDR080A01) consisting of 90-degree hybrids 404 and 406, are used to offset the phase of the current signal from the preceding signal by zero, π/4, π/2 and 3π/4 radians (0 degrees, 45 degrees 90 degrees and 135 degrees). Signal splitters 424 and 426, and mixers 410, 412, 420 and 422) are used to mix the current and delayed signals with the aforementioned phase shifts into four output channels, A, B, C, and D. The preferred IQ modulator outputs each of these signals through a filter 414 on to differential line pairs (pair A and C and pair B and D) with very low noise. The demodulator is designed to be insensitive to the amplitudes of the intermediate mixing states, detecting the location and polarities of the unbalanced (±1, 0) and balanced (±·2/2, ±√2/2) output pairs of the IQ modulators to decode the three-bit data from the differential phase shift. The demodulator State Table corresponding to the FIG. 6 demodulator is shown in Table 1. In Table 1 entries of “s” represent nominal relative amplitudes of √2/2. Amplitudes of voltage signals at nodes marked A, B, C, D, X, Y, LSB, 2SB and MSB in FIG. 6 are tracked for each differential phase shift state and are utilized to determine the values of the three bits of each symbol, at the rate of 3.4375 billion symbols per second.

The long delay line 400 shown in FIG. 6 used in the sequential state comparator is approximately one symbol period (291 ps) long and chosen to match an exact number of wave periods of the carrier; for instance exactly 21 cycles of a carrier at 73.5 GHz and exactly 24 cycles of a carrier at 83.5 GHz. This corresponds to between 2 and 3 inches of stripline or microstrip transmission line, so in preferred embodiments this component is fabricated off chip. Stabilization of this path length can be accomplished, using an error signal from a Costas-type loop as described below to provide a small incremental feed-back correction path or alternatively by varying the mixer bias levels slightly to affect the required phase adjustment. The 45 degree increment of ambiguity in the 8PSK Costas-type loop is large compared to the delay length variation that can be expected from electrical or thermo-mechanical effects, so the delay line should be adequately stabilized in all conditions.

TABLE 1

| Phase | | | | | | | | sgn(A + B + C + D) = | −sgn(X + Y) = | sgn(Y² − X²) = |
|---|---|---|---|---|---|---|---|---|---|---|
| Shift | Data | A | B | C | D | X = A² − C² | Y = B² − D² | MSB | 2SB | LSB |
| 0° | 000 | 1 | s | 0 | −s | 1 | 0 | −1 (0) | −1 (0) | −1 (0) |
| 45° | 001 | s | 1 | s | 0 | 0 | 1 | −1 (0) | −1 (0) | 1 |
| 90° | 010 | 0 | s | 1 | s | −1 | 0 | −1 (0) | 1 | −1 (0) |
| 135° | 011 | −s | 0 | s | 1 | 0 | −1 | −1 (0) | 1 | 1 |
| 180° | 100 | −1 | −s | 0 | s | 1 | 0 | 1 | −1 (0) | −1 (0) |
| 225° | 101 | −s | −1 | −s | 0 | 0 | 1 | 1 | −1 (0) | 1 |
| 270° | 110 | 0 | −s | −1 | −s | −1 | 0 | 1 | 1 | −1 (0) |
| 315° | 111 | s | 0 | −s | −1 | 0 | −1 | 1 | 1 | 1 |

### 8PSK Costas Loop

These 8PSK Costas-type loops exists in prior art. The one designed for this preferred embodiment is shown in FIG. 6A. It is used in this preferred embodiment to stabilize the path delay as an exact integral number of wavelengths. The modulated communication waveform can be mathematically described as:

$$S = a cos ( ω t ) + b cos ( ω t + \frac{π}{4} ) + c cos ( ω t + \frac{π}{2} ) + d cos ( ω t + \frac{3 π}{4} ) ,$$

where the eight defined 8PSK symbol states are represented by:

| Symbol | a | b | c | d |
|---|---|---|---|---|
| 000 | 1 | 0 | 0 | 0 |
| 001 | 0 | 1 | 0 | 0 |
| 010 | 0 | 0 | 1 | 0 |
| 011 | 0 | 0 | 0 | 1 |
| 100 | −1 | 0 | 0 | 0 |
| 101 | 0 | −1 | 0 | 0 |
| 110 | 0 | 0 | −1 | 0 |
| 111 | 0 | 0 | 0 | −1 |

In the receiver IQ modulator shown in FIG. 6, the received signal 406 is mixed with the reference signal 408 which has been delayed by an exact multiple of the carrier wave period plus some small error amount δ; the Costas loop is designed to minimize this error. After a short transient interval at the beginning of each symbol period (the difference between the symbol period of 290.9 ps and the delay line period of 285.7 or 287.4 ps), the two inputs to the mixer represent two successive bit phases offset by the encoded phase shift plus the small error amount. In order to minimize this error, the Costas loop uses as one input the modulated signal waveform corresponding to the present symbol state, and as the second input the delayed (previous) symbol state, defining the phase shift of the reference signal to be zero plus the small error:

R=cos(ωt+δ),

Multiplying the received signal by the reference signal into the A and C channels, with and without a π/2 phase shift respectively, and filtering the frequency doubled components,

$$\begin{matrix}\begin{matrix}A = \frac{a}{2} cos δ + \frac{b}{2} cos ( \frac{π}{4} + δ ) + \\ \frac{c}{2} cos ( \frac{π}{2} + δ ) + \frac{d}{2} cos ( \frac{3 π}{4} + δ ) \\ = \frac{1}{2} [ cos δ \{ a + \frac{\sqrt{2}}{2} b - \frac{\sqrt{2}}{2} d \} - \\ sin δ \{ \frac{\sqrt{2}}{2} b + c + \frac{\sqrt{2}}{2} d \} ] \\ = \frac{1}{2} [ I cos δ - Q sin δ ] ,\end{matrix} & [ Node 1 , shown in box in FIG . 6 A ] \\ \begin{matrix}C = \frac{a}{2} cos ( \frac{π}{2} + δ ) + \frac{b}{2} cos ( \frac{3 π}{4} + δ ) + \\ \frac{c}{2} cos ( π + δ ) + \frac{d}{2} cos ( \frac{5 π}{4} + δ ) \\ = - \frac{1}{2} [ cos δ \{ \frac{\sqrt{2}}{2} b + c + \frac{\sqrt{2}}{2} d \} + \\ sin δ \{ a + \frac{\sqrt{2}}{2} b - \frac{\sqrt{2}}{2} d \} ] \\ = - \frac{1}{2} [ Q cos δ - I sin δ ] ,\end{matrix} & [ Node 2 , in FIG . 6 A ]\end{matrix}$$

where we have defined

$$I ≡ a + \frac{\sqrt{2}}{2} b - \frac{\sqrt{2}}{2} d ; Q ≡ \frac{\sqrt{2}}{2} b + c + \frac{\sqrt{2}}{2} d .$$

Analyzing the 8PSK Costas loop, the mixers, amplifiers and summers in the loop create the products 2AC(C²−A²) and (C²−A²)²−(2AC)² and then mix (multiply) these to create the phase error signal. Evaluating these products:

$$\begin{matrix} 2 A C = \frac{1}{4} [ ( {Q}^{2} - {I}^{2} ) sin 2 δ - 2 IQ cos 2 δ ] , & [ Node 3 ] \\ {C}^{2} - {A}^{2} = \frac{1}{4} [ ( {Q}^{2} - {I}^{2} ) cos 2 δ + 2 IQ sin 2 δ ] , & [ Node 4 ] \\ \begin{matrix}2 A C ( {C}^{2} - {A}^{2} ) = \frac{1}{32} [ \{ {( {Q}^{2} - {I}^{2} )}^{2} - {( 2 IQ )}^{2} sin 4 δ - \\ 4 IQ ( {Q}^{2} - {I}^{2} ) cos 4 δ ] \\ = \frac{1}{32} [ Z sin 4 δ - W cos 4 δ ] ,\end{matrix} & [ Node 5 ] \\ \begin{matrix}{( {C}^{2} - {A}^{2} )}^{2} - {( 2 A C )}^{2} = \frac{1}{16} [ \{ {( {Q}^{2} - {I}^{2} )}^{2} - {( 2 IQ )}^{2} \} cos 4 δ + \\ 4 IQ ( {Q}^{2} - {I}^{2} ) sin 4 δ ] \\ = \frac{1}{16} [ Z cos 4 δ + W sin 4 δ ] ,\end{matrix} & [ Node 6 ]\end{matrix}$$

where we have defined

Z≡(Q²−I²)²−(2IQ)²; W≡4IQ(Q²−I²).

The error signal is derived from the product of these last two terms:

$$2 A C ( {C}^{2} - {A}^{2} ) [ {( {C}^{2} - {A}^{2} )}^{2} - {( 2 AC )}^{2} ] = \frac{1}{1024} [ ( {Z}^{2} - {W}^{2} ) sin 8 δ - 2 ZW cos 8 δ ] . \qquad [ Node 7 ]$$

Evaluating this error signal for all eight 8PSK symbol states, the error signal is independent of the symbol state (and therefore is not modulated at the symbol rate):

| | | | | | | | | | Node |
|---|---|---|---|---|---|---|---|---|---|
| Symbol | a | b | c | d | I | Q | Z | W | 7, Error Signal |
| 000 | 1 | 0 | 0 | 0 | 1 | 0 | 1 | 0 | sin(8δ)/1024 |
| 001 | 0 | 1 | 0 | 0 | √2/2 | √2/2 | −1 | 0 | sin(8δ)/1024 |
| 010 | 0 | 0 | 1 | 0 | 0 | 1 | 1 | 0 | sin(8δ)/1024 |
| 011 | 0 | 0 | 0 | 1 | −√2/2 | √2/2 | −1 | 0 | sin(8δ)/1024 |
| 100 | −1 | 0 | 0 | 0 | −1 | 0 | 1 | 0 | sin(8δ)/1024 |
| 101 | 0 | −1 | 0 | 0 | −√2/2 | −√2/2 | −1 | 0 | sin(8δ)/1024 |
| 110 | 0 | 0 | −1 | 0 | 0 | −1 | 1 | 0 | sin(8δ)/1024 |
| 111 | 0 | 0 | 0 | −1 | √2/2 | −√2/2 | −1 | 0 | sin(8δ)/1024 |

The output of each of demodulators 126 and 226 is three parallel on-off 3.4375 Gbps digital electrical signals representing the MSB, LSB and 2SB of an octal symbol on three separate parallel lines as shown in FIGS. 1A and 1B at 126A and 126B. These signals are converted from parallel to serial in converter circuits 127 and 227 which are clocked by clock recovery circuits 127A and 27A and time multiplier circuits 127B and 227B. The serial signal now a binary electrical signal at rates of 10.3125 Gbps which is converted in fiber converters 128 and 228 into optical signals for transmittal at 10.3125 Gbps out of the radios via an optical fiber.

### Design Considerations

Need for Flat Gain and Constant Group Delay

For these radios broad modulation/demodulation bandwidths will be carried through heterodyne or super-heterodyne up/down-conversion to result in transmitter/receiver front-end bandwidths covering up to 5 GHz of millimeter-wave frequency. As a result, millimeter-wave radio frequency transmitter and receiver components should exhibit flat gain (3 dB gain window) and constant group delay (<50 ps) characteristics over a much broader bandwidth than the counterparts in the lower-frequency microwave radios. E-Band radio designs should feature amplifier and filter components with extremely low variation in group delay in order to faithfully preserve the superposition of spectral components that makes up a clean, bit-error free signal waveform (eye-diagram).

Need for Large Dynamic Range

Due to the severity of rain fade at E Band, the radio should operate over an expected dynamic range far in excess of a typical microwave radio to accommodate heavy rain events. The transmitter must have the capability for changing output power over a large dynamic range on command.

Transmitter Output Power

Ultimate output power is less important in E-Band radio than at lower frequencies, because rain fade quickly nullifies the benefits of a few dB of extra power even over a relatively short (approximately 1 km) link. Antenna gain is much higher at millimeter-wave—relative to microwave—for a given antenna size, so effective radiated power (ERP) is greatly enhanced by antennas of modest size, further reducing the importance of an expensive and reliability-limiting power amplifier in the transmitter. An optimal E-Band radio design will have a typical output power not exceeding 200 milliwatts, but with flat gain and phase characteristics across the full operating band of the radio (1 to 5 GHz) and allowing for a large dynamic range in output power. At frequencies above 70 GHz high humidity and heavy rainfall results in substantial increases in atmospheric attenuation, so any excess link margin at these frequencies is needed to cope with weather-related signal fade, rather than for increased modulation efficiency.

Need for Low Oscillator Phase Noise

The local oscillator used as a frequency source in the transmitter multiplier chain and/or heterodyne transmitter/receiver up-converters and down-converters should have extremely low phase noise (integrated double-sideband phase noise less than 1 degree at the microwave frequency of the oscillator; less than 5 degrees after frequency multiplications to E Band), in order to maintain an adequate spacing between phase states and thereby avoid oscillator-induced bit errors.

Need for Low Order Modulation

The strong atmospheric attenuation associated with rain events is accompanied by large temporal variations in the signal amplitude and phase received from a remote transmitter. This effect makes it difficult to distinguish small differences in amplitude and phase imposed by a modulator from those imposed by the atmosphere, leading to high bit error rates from radios using high-order modulation schemes. The most robust modulation schemes are on-off keying and binary phase shift keying (OOK and BPSK), which require at least 1 Hz of bandwidth for each bit-per-second of data throughput. This modulation efficiency is acceptable for E-Band radios supporting up to at least 3.072 Gbps of data throughput (OBSAI protocols). For radios supporting 10-Gigabit Ethernet (10 Gig-E), the modulation efficiency must exceed 2 bits per second per Hz (e.g. 8PSK at 3 bits per second per Hz), but any higher order modulation schemes, typical of microwave radios, will be detrimental to radio performance.

Need for Amplitude-Insensitive Demodulator

The need for large power margin to accommodate rain events will often require the E-Band transmitter to transmit into the compression region of the output power amplifier. The symbol demodulator must be designed to be insensitive to amplitude, relying only on a power threshold and the polarity of the demodulated signals, so that the transmitter power amplifier may be pushed into compression during heavy rain events without significant degradation of symbol discrimination (bit error rate).

### Output Power and Spectrum Gain Control

For this preferred embodiment shown in FIG. 1 operating at data rates of the 10.3125 Gbps the occupied transmit bandwidth is between 3.5 GHz and 5 GHz. The transceiver is designed to provide a power spectral density, over more than 70 percent of occupied bandwidth of the transmitter which is constant to within +/−1.5 dB and the transceiver provides a dynamic range in power output exceeding 15 dB.

### Comparison with Prior Art Chipset Radios

As explained in the background section recent advances in semiconductor technology have enabled the fabrication of increasingly complex mixed-signal (analog/digital) circuitry on a single integrated circuit chip or a chipset containing a minimal number of chips. Such circuitry has included analog microwave and millimeter-wave front-end amplifiers, filters, oscillators, and mixer/down-converters, as well as intermediate-frequency electronics, phase-lock loops, power control and back-end analog baseband circuitry, along with digital modulators and de-modulators, clock recovery circuits, forward error correction and other digital data management functions. Mixed-signal integrated chip solutions for wireless communications have universally evolved from RF frequencies below 1 GHz (e.g. 900 MHz handsets for wireless telephone in the home) to low microwave frequencies (analog/digital cell phone technology with carrier frequencies up to 2 GHz), to high microwave and low millimeter-wave frequencies (6 to 38 GHz) for wireless point-to-point broadband communications. Most recently, radio receivers and transmitters have been demonstrated using single-chip circuits at frequencies in the license-free band spanning 57 to 64 GHz. At these transmit frequencies the radios operate at very short distances due to the absorption of the radio beam by oxygen in air. These circuits have been based on techniques that have been successful to lower frequency radios. For example, these prior art radio-on-a-chip designs have featured heterodyne and super-heterodyne circuits with relatively narrow (<1 GHz) baseband frequency channels for modulation and demodulation, because the symbol rate was constrained far below 1 billion symbols per second by the channel bandwidth available for microwave radios. Embodiments of the present invention are designed to utilize the entire available bandwidth, greater than 1 GHz, for modulation and demodulation. Optimal designs for Applicants' radio chips will utilize baseband modulation bandwidths of 1 to 5 GHz to make use of the preferential rules including E-Band rules allowing occupation of up to 5 GHz of contiguous spectrum per half-duplex radio path.

### Second Preferred Embodiment

### Applicants' Second Preferred 10-GigE Radio

Applicants' second preferred embodiment is also a 10 GigE radio with 8PSK modulation and is very similar to the first preferred embodiment. This second preferred embodiment is described in detail below:

Benefits of 8PSK Modulation

At a given data rate, an 8PSK-modulated radio operates at a two-times higher symbol rate than a more common 64-QAM-modulated radio, necessitating higher-performance and more expensive digitizers, digital-to-analog converters, and digital logic components. However, the sparser 8PSK constellation allows error-free operation at 5 dB lower signal-to-noise ratio than 64-QAM. Because the signal is transmitted at full power for every constellation point, power efficiency is 8 dB higher than 64-QAM. Since amplitude is fixed for all constellation points, the transmitter need not be backed off from full power but can be operated well into compression, offering another 7 dB advantage over 64-QAM. Combined, these advantages contribute an additional 20 dB to the link margin for an 8PSK radio relative to an equivalent 64-QAM radio, which translates to about a 75% longer path reach in a “four nines” (99.99% weather available) path.

Transmitter

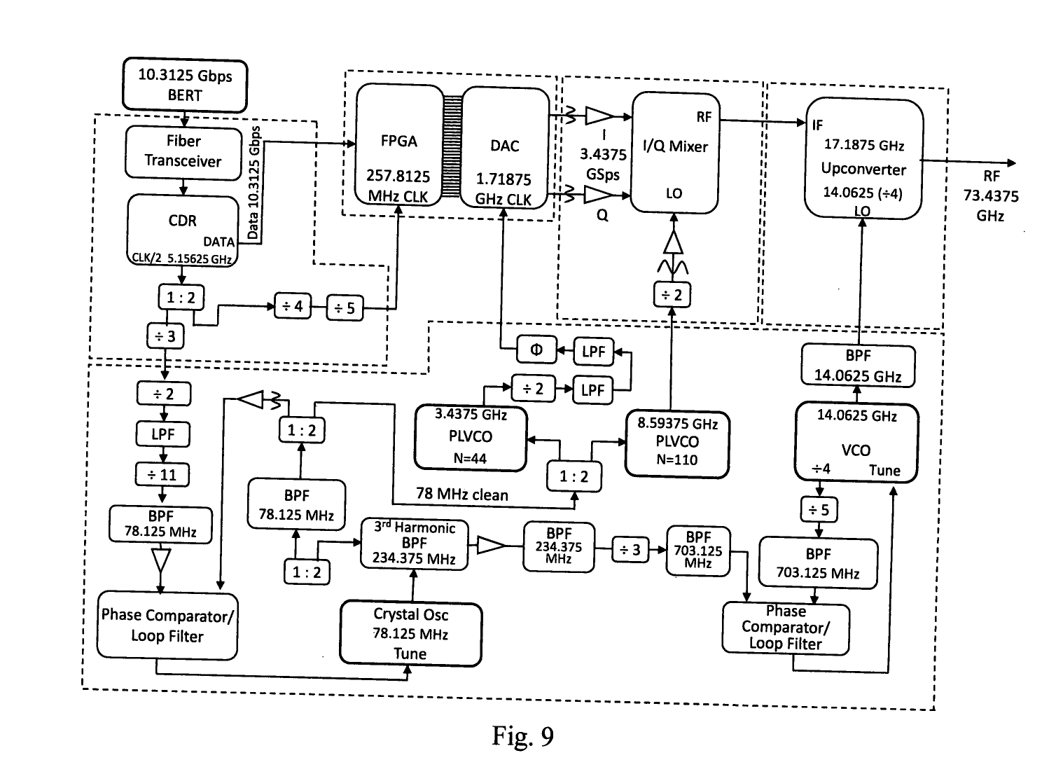

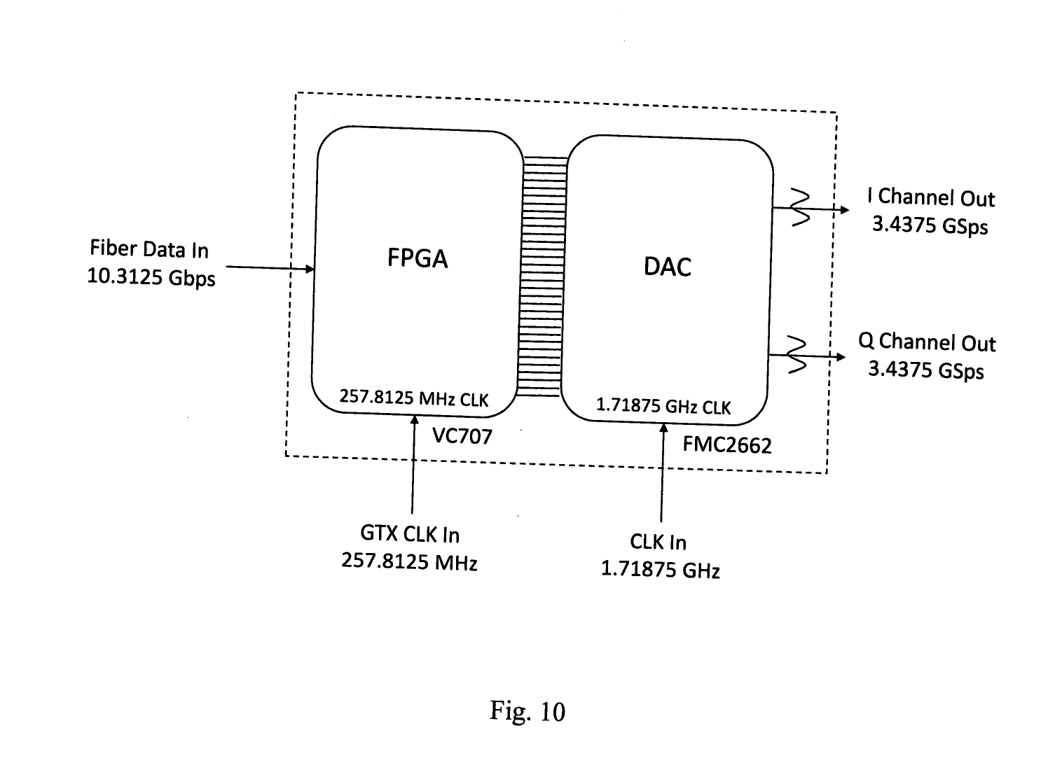

In this second preferred embodiment, the transmitter (FIG. 9) for each radio transceiver supports a digital data rate of 10.3125 Gbps (10 Gigabits raw data per second plus IEEE 802.3 Clause 49 64b/66b encoding which accounts for the 0.3125 Gbps excess). Using 3-bit symbol encoding (differential 8PSK), the carrier phase is modulated at a symbol rate of 3.4375 billion-symbols-per-second, so as to fit easily into the 5 GHz channel modulation bandwidth allowed by the prevailing FCC band plan for E-Band communication. Serial data awaiting transmission is loaded at 10.3125 Gbps into a fast 40-bit serial buffer input of a Field-Programmable Gate Array (FIG. 10) and then clocked into the array processor at the slower rate of 257.8125 MHz (the ratio of the 10 GigE bit rate [i.e. 10.3125 Gbps] and the buffer length [40 bits]). In the FPGA, the bits are segmented sequentially into groups of three, one group representing each one data symbol to be transmitted by the D8PSK modulator.

Gray Coding

Gray coding was invented in 1947 by Frank Gray of Bell Laboratories as a means of reducing the number of erroneous bits transmitted in a noisy signal channel or noisy switching environment. The basic tenet of the invention is that data errors most often arise from mistaking symbol phase near the boundary between phase states; for instance when the phase of a noisy signal measured at 157° degrees actually represents the 180° symbol state, but is interpreted to belong to the slightly closer 135° symbol state. For a simple encoding scheme it is possible for such adjacent symbol phases to represent strongly different bit sequences: for instance the 135° state might represent the bits ‘011’ while the 180° state represents the bits ‘100.’ In this case an error between the two adjacent states results in all three data bits being in error. The Gray code imposes a special sequence to the bit strings such that all adjacent phase states represent bit sequences that differ by only a single bit state, for instance:

| | |
|---|---|
| 0° | 000 |
| 45° | 001 |
| 90° | 011 |
| 135° | 010 |
| 180° | 110 |
| 225° | 111 |
| 270° | 101 |
| 315° | 100 |

Differential Gray Coding

With differential Gray coding, the phase state represented by each three bit Gray code is imposed as a modulator phase shift, rather than an absolute phase, at the subsequent cycle of the symbol clock. This technique eliminates the need for the local transmitter and remote receiver to share knowledge of a common absolute phase reference.

I/Q Modulator

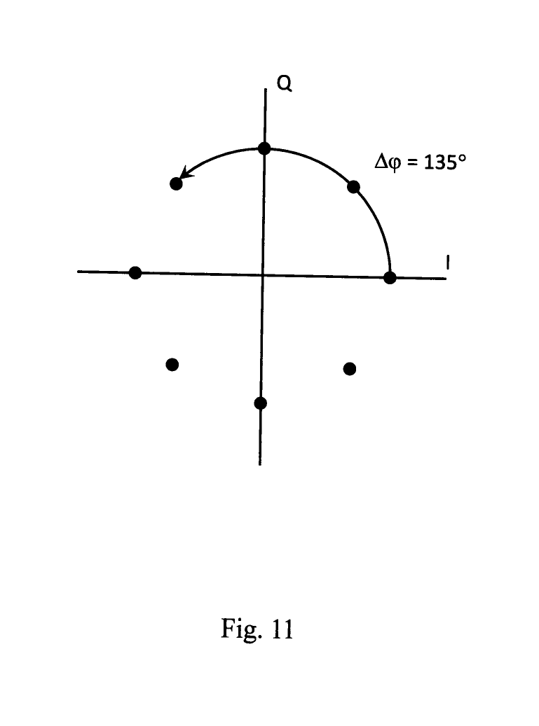

Differential Gray coding of the data stream yields a progression of phase jumps that modulate the MMW carrier to encode the data. Graphically, these phase jumps push the MMW carrier phase around a circle on the phase (or I/O) plot, as shown in FIG. C. For instance, when the remote receiver recognizes a phase jump near 135°, it recognizes the transmitted data string as a ‘010’, per the previous table. Signal vector phase is stepped in the transmitter modulator by use of a pair of mixers modulating an intermediate-frequency (IF) carrier in quadrature—that is to say on two separate channels that are separated by 90° of the IF carrier frequency (see Figure C). One channel, the “cosine,” or “in-phase” (I) channel, modulates the signal amplitude along the real (x) axis of the phase plot (figure N); the other channel, the “sine,” or “quadrature” (Q) channel, modulates the signal along the imaginary (y) axis. The vector plot of symbol amplitude and phase, accumulated over many symbol periods, becomes the symbol “constellation,” which is shown for D8PSK modulation in FIG. 11.

Intermediate Frequency Carrier Phase Noise

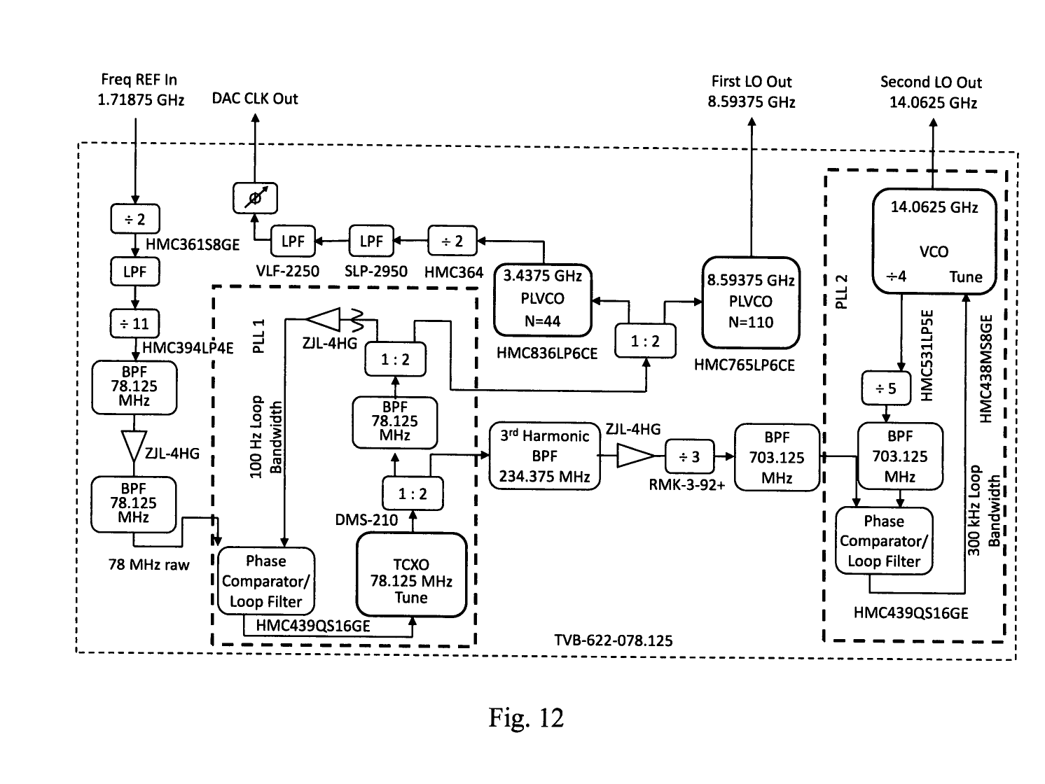

Bit-error performance of a digital data link is a statistical concept, based on the likelihood of phase and amplitude noise on the signal exceeding the phase and amplitude spacing between points on the constellation. The 8PSK constellation has only one amplitude state, so phase noise is much more important than amplitude noise in determining bit-error rate. The convenience of using Differential 8PSK encoding comes at a price in radio noise sensitivity, since both the preceding and the current bit contribute noise to the measurement of phase change at the clock cycle. In order to achieve error-free transmission (10⁻¹² bit-error rate), the threshold for phase noise on the IF carrier is very low (about 0.6 degrees, or about 100×10⁻¹⁵ seconds of jitter). Phase noise suppression to this level is accomplished through the use of an ultra-low-noise phase-locked voltage controlled oscillator, driven by high-quality temperature-controlled crystal oscillator at around 78.125 MHz, and a phase-lock loop with a loop bandwidth in the range of 100 Hz (FIG. 12).

Digital-to-Analog Converters (DACs)

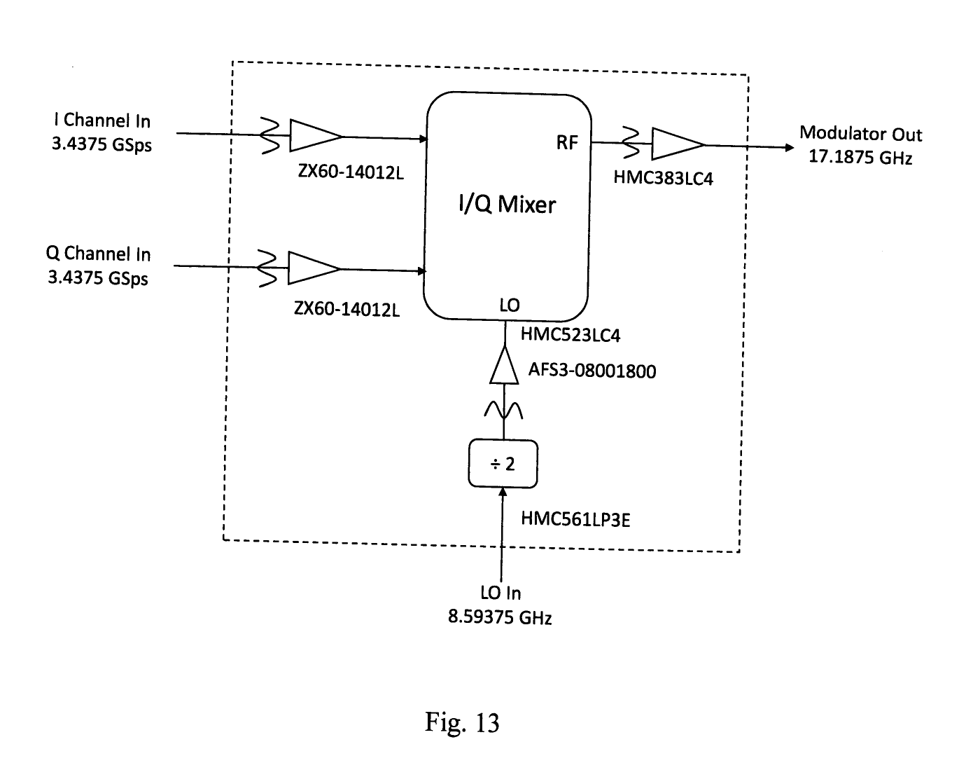

In order to jump to a specific position in the symbol constellation, the voltages at the vector modulator (I/Q mixer) inputs as shown in FIG. 13 must be driven to positive and negative levels proportional to the x- and y-magnitudes of the constellation point as shown in FIG. 11. Two independent DAC channels controlled by the FPGA (FIG. 10) are used to drive the x- and y-magnitudes. For D8PSK modulation, these DACs are driven to place the D8PSK constellation points at fixed 45° intervals around a fixed radius circle.

After each interval of the symbol clock (approximately 291×10⁻¹² seconds), three sequential bits of new data are evaluated by a D8PSK Gray Encoder in the FPGA to determine how far the phase should progress on the next cycle, and by comparison with the I/Q phase of the previous symbol, what precise carrier phase should be imposed by the I/O mixer. At the next clock cycle, appropriate digital controls are sent to the two independent DAC channels to drive the carrier to that phase state.

DAC Pre-compensation

At the time of this writing, practical DACs operating at speeds of 3 GigaSymbols per second (3 GSps) and higher typically utilize dual-channel architectures in which successive analog voltages are driven in a “ping-pong” fashion between two slower devices. The switch between the two channels does not provide perfect isolation, resulting in an undesirable persistence from one data sample to the next. In order to keep the transmitted signal constellation as close to the ideal pattern (shown in FIG. 11) as possible, a pre-compensating Look-Up Table (LUT) is loaded into the FPGA to dictate the DAC drive levels. The LUT lists the 8-bit digital DAC drive levels, for both I and Q channels, for each combination of new and old constellation position, which will drive the modulation vector to the exact desired location on the D8PSK constellation (FIG. 11).

MMW Up-Converter

After vector (I/Q) modulation, the IF carrier is up-converted to the MMW transmit frequency and sent to the transmitter power amplifier and antenna.

Up-Converter Phase Noise

Similarly to the IF carrier, the phase noise of the upconverter oscillator affects the bit-error performance of the 10 GigE radio. An ultra-low-noise VCO is phase-locked at a multiple (9×) of the temperature-controlled crystal, with a loop bandwidth of about 300 kHz, to achieve a phase noise of about 2.2 degrees at near 60 GHz (100 fs of jitter), where it acts as the local oscillator to drive the MMW up-converter mixer (FIG. 12).

System Clock

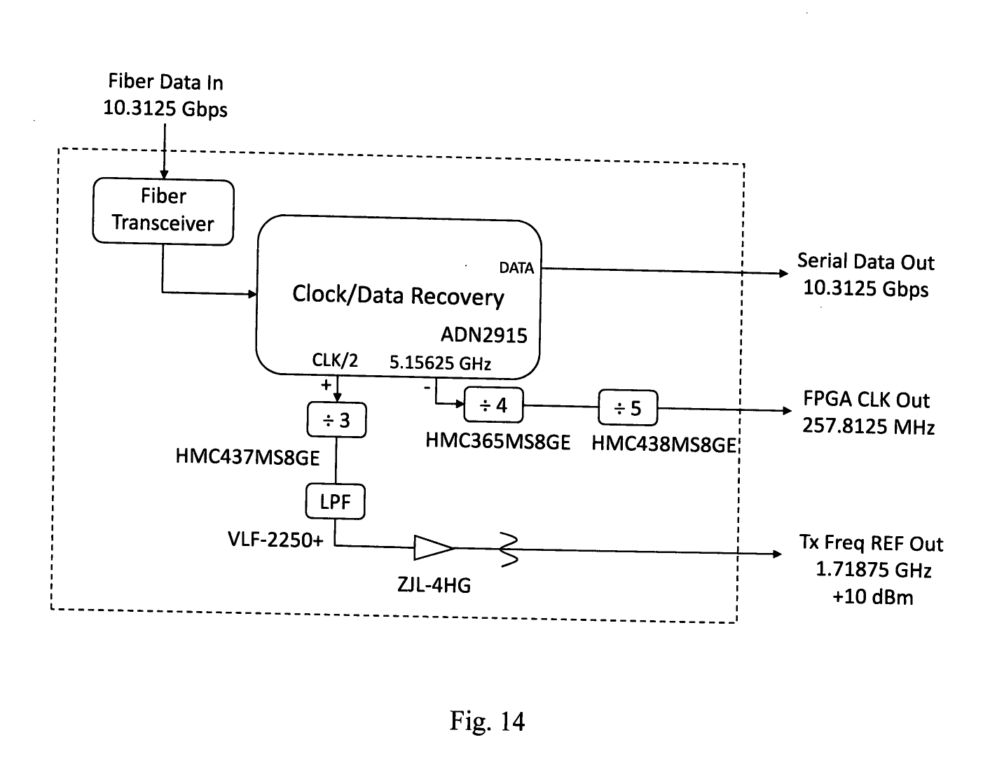

The master clock for the transmitter is derived from the 10 GigE input data line. A clock-and-data recovery circuit at the input (FIG. 14) strips the clock and divides it by 132 to tune the temperature-controlled crystal oscillator to a frequency near 78.125 MHz. Data clock jitter is smoothed by the ˜100 Hz loop bandwidth of a phase lock loop at the crystal frequency. The crystal oscillator then becomes the low-phase-noise reference frequency for both the IF carrier and the MMW upconverter. The recovered raw data clock is also divided by 40 to drive the FPGA clock each time the 40-bit serial data buffer is filled and ready for parallel transfer, and divided by 3 to drive the DAC at the 3.4375 GSps symbol rate.

A significant and critical feature of this timing architecture is that the MMW carrier frequency is in fact derived from the recovered GigE data clock, and is thereby allowed to “float” (within limits) with the input data rate. For a transmitter in the 71-76 GHz band, for instance, the data clock is divided by a factor of 132 to tune the 78.125 MHz crystal, and then split to two separate multipliers—a 220× multiplier that generates the first IF (17.1875 GHz), and a 720× multiplier that acts as the MMW upconverter local oscillator (56.25 GHz). The sum of these two frequencies, 73.4375 GHz, becomes the carrier frequency near the center of the 71-76 GHz band. The carrier frequency is thus a rational multiple of the data rate as follows: 10.3125*(220+720)/132=73.4735 GHz. For the 81-86 GHz Band, the IF multiplier changes from 220 to 204 and the MMW LO multiplier changes from 720 to 864, such that the carrier frequency becomes 10.3125*(204+864)/132=83.4375 GHz. This feature of a common frequency reference for data clock and carrier frequency generation allows the remote receiver to exactly recover the signal carrier frequency without a Costas loop, simply by repeating the rational multiplication sequence on the recovered data clock.

Receiver

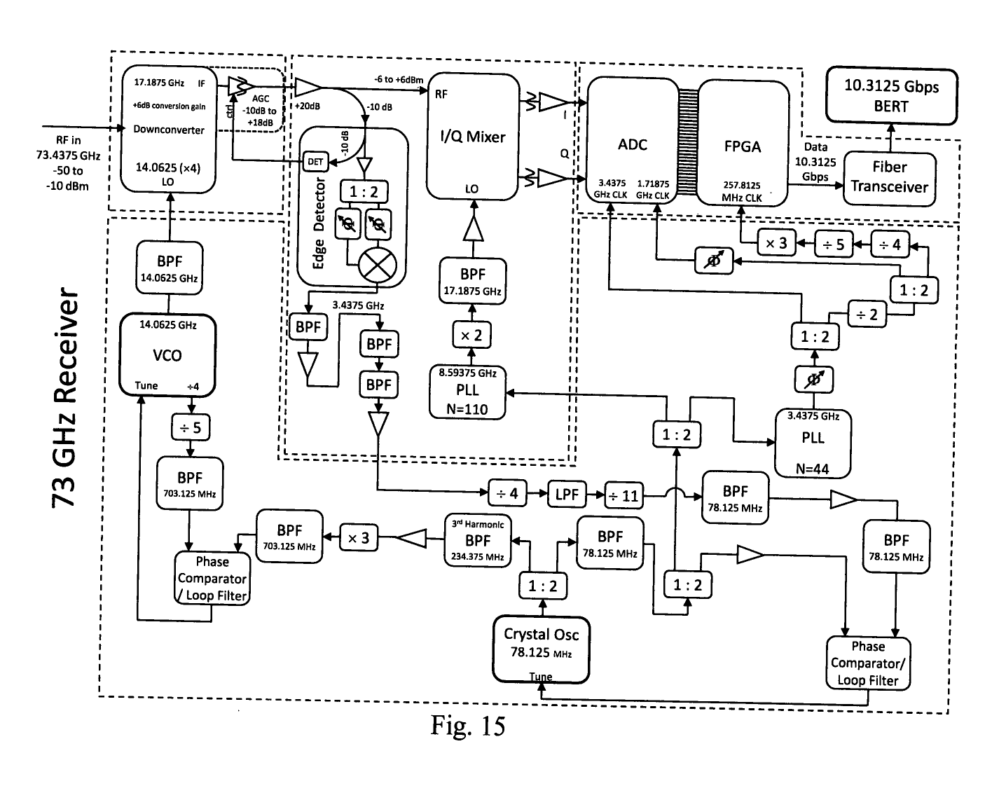

In this second preferred embodiment, the receiver (FIG. 15) detects and demodulates the MMW signal from the remote D8PSK transmitter using clock and frequency references derived from the received data signal. This is made possible by the transmitter design feature that the RF carrier, the IF carrier and the symbol clock are all derived from the data clock recovered at the transmitter input.

Down-Converter

In the receiver, the MMW signal is downconverted using the same frequency plan (RF, IF and baseband frequencies) used in the remote transmitter.

Clock, Carrier and Data Recovery

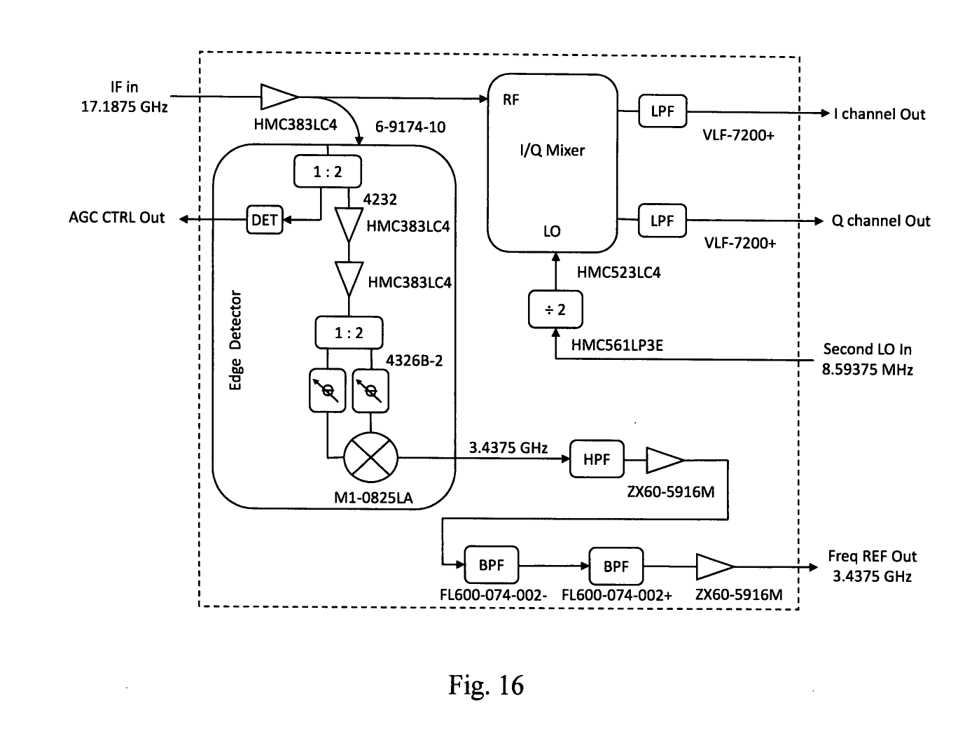

After down-conversion, the IF signal is fed to a data demodulator. Along this feed, a small portion of the signal power is split off and directed into an edge detector circuit to recover the clock from the remote transmitter (FIG. 16). In this sense the local receiver is the “slave” to the “master” clock generated at the remote transmitter. [This also highlights the fact that the local transmitter and local receiver do not share a common clock—each transmitter carries the master clock for the receiver at the other end of the link]. At the 10 GigE standard data rate of 10.3125 Gbps and for the D8PSK data modulation carrying 3 bits per symbol, the recovered clock is at or very near 3.4375 GHz.

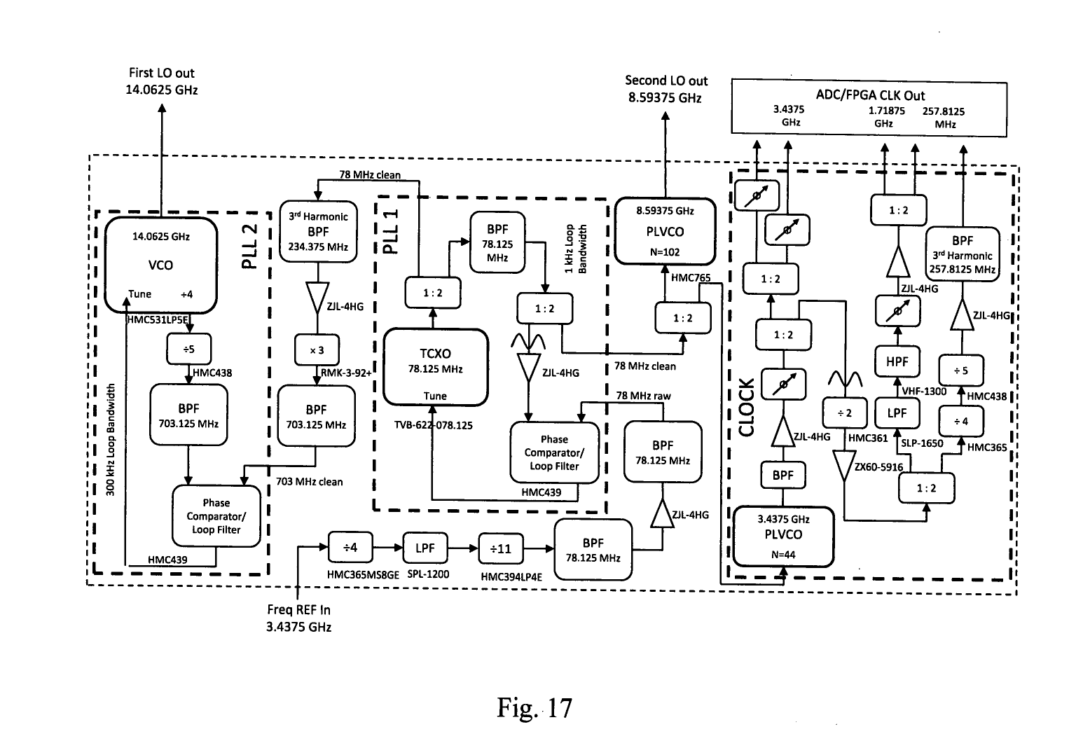

As in the transmitter, the recovered data clock reference is divided by a factor of 132 to tune an ultra-stable temperature-controlled crystal oscillator at 78.125 MHz (FIG. 17). In the receiver, this crystal is phase-locked at a loop bandwidth of 1 kHz, somewhat higher than the loop bandwidth used in the transmitter to allow it to track transmitter drifts, but low enough to minimize added phase noise and associated increase in the error vector magnitude (EVM) of the received signal constellation. The IF and MMW local oscillator frequencies are generated by the same integer multiples of the TCXO as those used in the remote transmitter, to lock the receiver to the carrier frequency of the remote transmitter, without the use of a Costas loop.

The larger fraction of the IF signal goes into an I/Q mixer of the same type used in the transmitter; here it is separated into its vector “in-phase” (I) and “quadrature-phase” (Q) channels. Since there is no absolute phase reference connecting the local receiver and remote transmitter, the recovered constellation may be rotated by an arbitrary amount relative to the transmitted constellation, but the Differential 8PSK encoding scheme ensures that only the phase change between symbols, and not the symbol phases themselves, are needed to decode the data.

Edge Detector

Another significant and critical feature of the radio architecture is the edge detector that recovers the remote master clock. In this circuit, shown in FIG. 17, the IF signal is split into two equal parts and recombined (mixed) after imposing a differential time delay of a ½-period of the IF carrier frequency, equivalent to about 10% of a symbol period. In the absence of sudden jumps in phase, the two inputs to the mixer are then out of phase and the mixer output is nulled. However, when the phase changes abruptly at the part of a new symbol, there is a period of one-half IF cycle where the two mixer inputs are not perfectly out of phase, and the power level at the output of the mixer spikes temporarily before settling back to zero for the rest of the symbol period. The amplitude of transition spikes vary depending upon the degree of phase change at the individual symbol edges, but the output of the edge detector is amplified to strongly to clip the spikes and then filtered in a narrow band around 3.4375 GHz so that only the fundamental clock frequency and fiducial timing phase are preserved.

Signal Demodulation

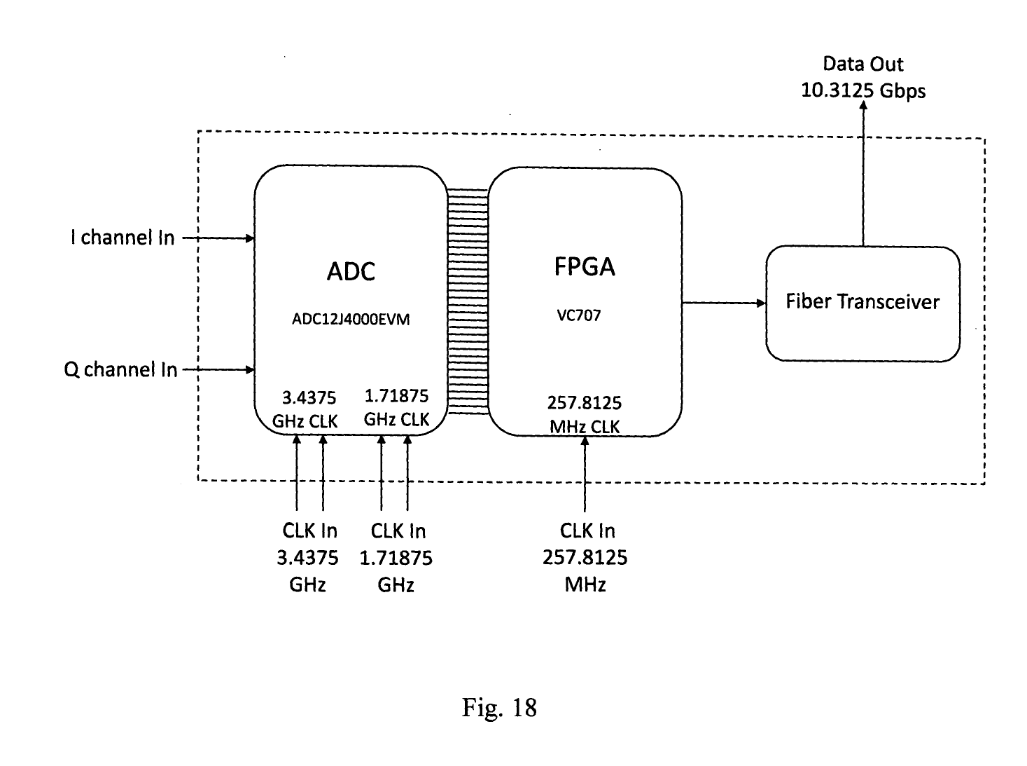

The I and Q outputs of the quadrature mixer are digitized in separate analog-to-digital converter (ADC) channels, and 12-bit digital data is streamed from each ADC synchronously into an FPGA (FIG. 18). In the FPGA, the I and Q waveforms are cleaned with an Inter-Symbol Interference (ISI) Equalization Filter to compensate signal distortion arising from band limiting of the transmitted signal. Vector phase is then determined through the ratio of the cleaned Q and I amplitudes (tangent of phase is Q/I) and compared with the phase of the previous symbol to determine the size of the phase jump. This measured phase jump is sorted into one of eight discrete 45-degree sector intervals and then compared against the Differential Gray Code table to recover the three bits encoded in the symbol step.

ISI Equalization Filter

The transmitted spectrum is restricted, by FCC regulations, to a fixed bandwidth (5 GHz in the 71-76 and 81-86 GHz bands). At a transmit symbol rate of 3.4375 GSps, third- and higher harmonics of the modulation spectrum must be filtered out prior to transmission over the air. This filtering leads to distortion of the signal waveform that must be compensated in the receiver prior to signal decoding. The compensation is applied as a form of Finite Impulse Response (FIR) filter, created by comparing a received signal waveform with a known reference copy of that waveform as generated, prior to channel filtering, in the remote transmitter. An inverse transfer function is computed such as to digitally reciprocate the received waveform in the FPGA and recreate the original, undistorted modulation waveform prior to data decoding. The implemented filter samples and compensates the received waveform through impulse samples at a number of “taps,” separated by single periods of the symbol rate.

### Variations

Although preferred embodiments of the present invention have been described in detail above, persons skilled in the radio art will recognize that many variations are possible within the scope of the present invention. Some variations are listed below.

### Other High Data Rate Millimeter Radios

Applicant has described a preferred embodiment of a radio supporting a data rate of 10 Gbps using a differential octal phase shift keyed (DBPSK) modulator; however the radio on a chip or minimal chipset should not be considered to be bound by this data rate or modulation approach. Indeed at lower data rates, more robust modulation approaches such as DBPSK or DQPSK may be employed and would allow for bit-error-free operation at lower link margins.

A popular data transfer standard supported by one radio sold by Applicant is the Gigabit-Ethernet (GigE) standard which exchanges data at a rate of 1.25 Gbps. At this rate, and for data rates up to about 3.5 Gbps, the preferred modulation scheme is Differential Binary Phase Shift Keying (DBPSK), where the difference between phase states (180 degrees) is four times larger than for D8PSK (45 degrees), and consequently a lower signal-to-noise ratio is required to distinguish between phase states. The DBPSK design is described in parent application Ser. No. 12/928,017 which has been incorporated herein by reference. FIG. 7 is a circuit drawing based on conventional circuitry. In accordance with the present invention these circuits would be fabricated on a single chip or chipset utilizing well-known integrated circuitry fabrication techniques as explained above with respect to the first preferred embodiment. Beyond data rates of 3.5 Gpbs, the Federal Communication Commission allocated channel bandwidth becomes insufficient to support the modulation rates, and it becomes necessary to transmit data “symbols” representing more than one data bit at a time. For radios supporting data transfer rates between 3.5 Gbps and about 7 Gbps, the preferred modulation approach is Differential Quadrature Phase Shift Keying (DQPSK), in which two bits of data are sent simultaneously within each “symbol,” and the spacing between the four possible symbol phase states is 90 degrees. For radios supporting data rates between 7 Gbps and about 10.5 Gbps, the preferred modulation approach is Differential Octal Phase Shift Keying (D8PSK), in which three bits of data are sent simultaneously, as described in the first preferred embodiment for this patent. For radios supporting even higher data rates the modulation scheme is chosen to send four or more bits of data simultaneously, and the link margin (or signal-to-noise ratio) required to maintain error-free transmission becomes successively higher. Chip-based radio transceivers designed for a range of data transfer rates less than the threshold rates of 3.5 Gbps, will preferably include modulator/demodulators of the DBPSK types. For data rates above 3.5 Gbps and below 7.0 Gbps, DQPSK is preferred. And for rates above 7.0 Gbps and below 10.5 Gbps, D8PSK is preferred.

### Silicon-Germanium Semiconductors

The components of the millimeter wave radios described above are in general state of the art millimeter wave and optical fiber components. However, many of the components could be fabricated together on one or more semiconductor substrates to produce very low cost millimeter wave radios. Silicon-germanium bipolar transistors on complementary metal-oxide-semiconductor (referred to as “SiGe BiCMOS”) technology, which marries the superior low-noise and high-speed properties of the SiGe heterojunction bipolar transistors with the low cost and manufacturability advantages of conventional CMOS technology, represent an ideal solution for mixed-signal applications such as millimeter-wave wireless communications systems, in which frequency sources and multipliers, mixers and low-noise amplifiers are used alongside digital modulator control and processing circuitry. Amplifiers using SiGe bipolar transistors are more efficient and achieve lower noise figures than comparable conventional CMOS amplifiers, and the higher breakdown voltage of SiGe allows for higher device output power as well:

### High Frequency Radio Components on Si and SiGe

Gallium Arsenide (GaAs) is superior to SiGe semiconductors for ultra-low phase noise high-frequency oscillators (so an external microwave phase-locked voltage-controlled oscillator (PLVCO) is a preferred frequency source), but the frequency multiplier chain, up-conversion and down-conversion mixers and millimeter-wave, microwave and baseband amplifiers can all be implemented satisfactorily using conventional microstrip circuitry on Si and SiGe semiconductor substrates. For lowest cost, a silicon wafer can be used as a substrate, with germanium placed locally on the chip at the locations of the millimeter-wave transistors and diodes, so that the more expensive SiGe material is localized only in the regions of the high-frequency MMW and microwave semiconductor junctions. Lower frequency circuitry, including the data encoder, high-speed driving logic and all other baseband and digital data and control electronics may be implemented using standard CMOS processes on the same silicon substrate. The data decoder and delay-stabilizing Costas loop can be implemented on the receiver chip, but due to its physical size the longer symbol-period delay line is best implemented off-chip, using a microstrip line on a flex-circuit material such as Rogers 3003 or using a waveguide delay line. A SiGe foundry, such as the IBM foundry located near Essex Junction, Vt., with a 0.13-micron or 0.09-micron SiGe process can produce SiGe chips of the preferred design for 10 Gbps E-Band radio transceivers.

### Other Variations

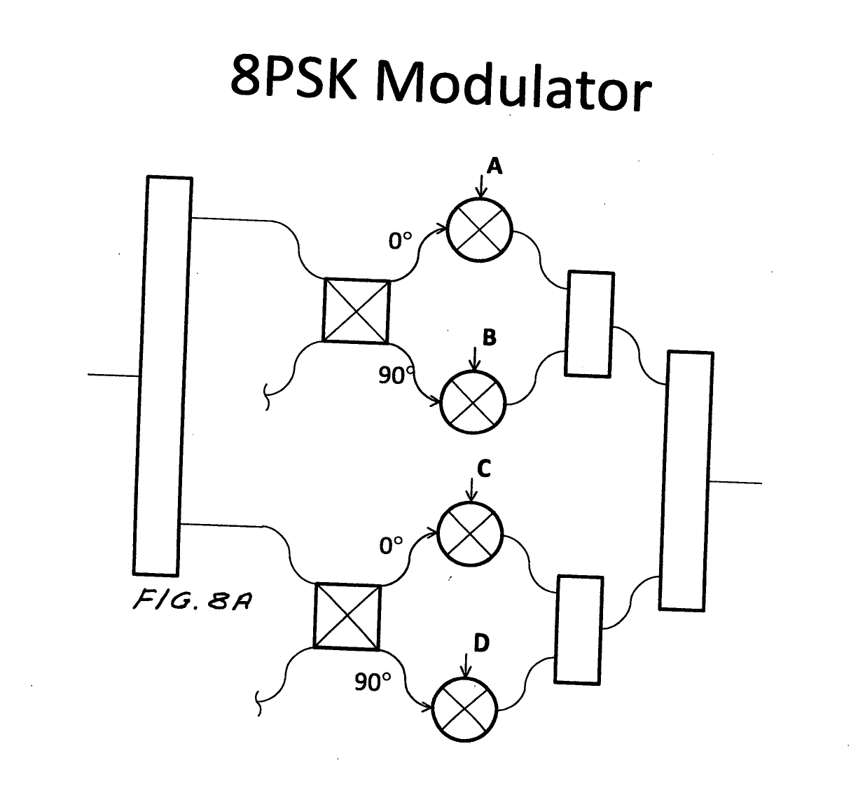

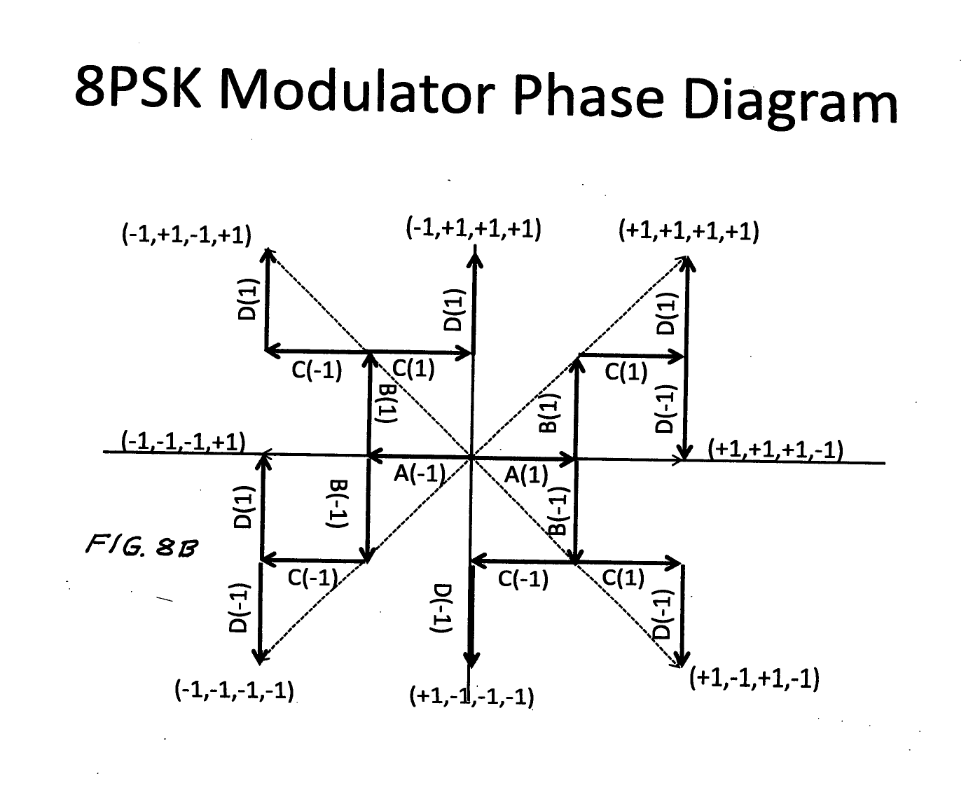

FIGS. 8A and 8C show features of a variation where the 45 degree delay line 350 shown in FIG. 1A is omitted.

The radio described in this patent is capable of delivering data rates in excess of 3.5 Gigabits per second. The preferred embodiments in this description operate under the Internet Protocol (IP) Ethernet Standard at 10 Gigabits per second with a small amount of overhead for ensuring bit toggling at some minimum speed. There are, however, many other communications standards which involve serial transfer of binary data at speeds in excess of 3.5 Gigabits per second and within the maximum bandwidth capability of this radio. Some of these include:

SONET OC-96 (4.976 Gbps)

4×Gig-E (5.00 Gbps)

5×Gig-E (6.25 Gbps)

OBSAI RP3-01 (6.144 Gbps)

6×Gig-E (7.50 Gbps)

Fibre Channel 8GFC (8.5 Gbps)

SONET OC-192 (9.952 Gbps)

Fibre Channel 10 GFC Serial (10.52 Gbps)

The High Data Rate Wireless Communications Radio described in this patent will support all of these protocols and a variety of others, up to a maximum data rate of about 13 Gbps. In preferred embodiments operating at data rates in the range of about 3.5 Gbps the occupied transmit bandwidth should be between 1.0 GHz and 5 GHz. For the higher data rates the transmit bandwidth will preferably be in a range closer to the 5 GHz limit.

Therefore readers should determine the scope of the present invention by reference to the appended claims.

What is claimed is:

1. A two-transceiver E-Band radio link, defining a first transceiver and a second transceiver, with 8PSK modulation and demodulation, capable of 10.3125 Gbps operation, said link comprising:
A. a first transceiver adapted to transmit at a first E-Band frequency band and to receive at a second E-Band frequency band, each of the two bandwidths, defining a first and second E-Band bandwidth, each being at least as wide as 3.5 GHz, said transceiver comprising:
1) transmitter front-end circuitry adapted to receive a binary input data stream with a capability of producing output signals at data rates at least as fast as 10.3125 Gbps utilizing 8PSK modulation of an E-Band carrier signal, said transmitter front-end circuitry comprising:
a. encoding circuitry adapted to encode input binary signals to produce encoded signals, with each encoded signal comprising three bits; and
b. 8PSK modulation circuitry adapted to phase shift the millimeter wave carrier signal based on the encoded signals to produce a phase-shifted carrier signal at the first E-Band frequency band with each phase of the signal defining one of eight phases, having spacing between the phases of about 45 degrees or a multiple of about 45 degrees;
2) receiver circuitry adapted to receive incoming E-Band signals transmitted from the second transceiver at the second E-Band frequency millimeter wave transmitter, said receiver circuitry comprising:
a. millimeter wave amplifier circuitry adapted to amplify incoming E-Band signals;
b. demodulation circuitry adapted to demodulate the amplified incoming millimeter wave signals to produce a binary output data stream;
3) radio transmit and receive components adapted transmit and receive phase shifted E-band radio signals to and from the second transceiver, said radio components comprising:
a. a millimeter wave amplifier circuitry adapted to amplify phase shifted carrier signal to produce an amplified phase shifted transmit E-Band radio beam,
b. a millimeter wave amplifier circuitry adapted to amplify phase shifted carrier signals received from the second transceiver;
4) an antenna system adapted to convert the phase shifted E-band radio transmit beams to produce a narrow band E-Band “pencil beam” confined within a single narrow channel less than 1.2 degrees wide and to collect phase shifted E-band radio beams transmitted from the second transceiver;
B. a second transceiver adapted to transmit at a first E-Band frequency band and to receive at a second E-Band frequency band, each of the two bandwidths, defining a first and second E-Band bandwidth, each being at least as wide as 3.5 GHz, said transceiver comprising:
1) transmitter front-end circuitry adapted to receive a binary input data stream with a capability of producing output signals at data rates at least as fast as 10.3125 Gbps utilizing D8PSK modulation of an E-Band carrier signal, said transmitter front-end circuitry comprising:
a. encoding circuitry adapted to encode input binary signals to produce encoded signals, with each encoded signal comprising three bits; and
b. 8PSK modulation circuitry adapted to phase shift the millimeter wave carrier signal based on the encoded signals to produce a phase-shifted carrier signal at the first E-Band frequency band with each phase of the signal defining one of eight phases, having spacing between the phases of about 45 degrees or a multiple of about 45 degrees;
2) receiver circuitry adapted to receive incoming E-Band signals transmitted from the second transceiver at the second E-Band frequency millimeter wave transmitter, said receiver circuitry comprising:
a. millimeter wave amplifier circuitry adapted to amplify incoming E-Band signals;
b. demodulation circuitry adapted to demodulate the amplified incoming millimeter wave signals to produce a binary output data stream;
3) radio transmit and receive components adapted transmit and receive phase shifted E-band radio signals to and from the first transceiver, said radio components comprising:
a. a millimeter wave amplifier circuitry adapted to amplify phase shifted carrier signal to produce an amplified phase shifted transmit E-Band radio beam,
b. a millimeter wave amplifier circuitry adapted to amplify phase shifted carrier signals received from the first transceiver;
4) an antenna system adapted to convert the phase shifted E-band radio transmit beams to produce a narrow band E-Band “pencil beam” confined within a single narrow channel less than 1.2 degrees wide and to collect phase shifted E-band radio beams transmitted from the first transceiver.

2. The radio link as in claim 1 wherein all or mostly all of the transmitter front-end circuitry and the receiver circuitry of both transceivers are fabricated on a single chip or chipset,

3. The radio link as in claim 1 wherein the 8PSK modulation circuitry is D8PSK modulation circuitry.

4. The radio link as in claim 1 wherein the transmitter front end circuitry of both transceivers are adapted to derive their internal clock references directly from 10 GbE fiber or coaxial cable data input.

5. The radio link as in claim 4 wherein the transmitter front end circuitry of both transceivers are adapted to generate symbol clock, intermediate frequencies and transmit frequencies from their internal clock references.

6. The radio link as in claim 5 wherein the receiver circuitry in both transceivers derive their receiver symbol clock from their 10 GBE antenna data input with a result that receiver internal symbol clock of each of the transceivers is slaved to the transmitter clock of the other transceiver and fully independent of internal transmit clock of the transceiver.

7. The radio link as in claim 6 wherein the receiver circuitry of each of the two transceivers utilizes an edge detector comprised of a delay and sum interference circuit, using a half wave delay of the intermediate frequency receive signal to detect and synchronize to phase jumps.

8. The radio link as in claim 7 wherein the receiver circuitry of each of the two transceivers is adapted to generate its symbol clock, intermediate frequencies and local oscillator frequencies from its internal receive clock eliminating a need for a Costas loop or other carrier recovery circuit.

9. The radio link as in claim 8 wherein the receiver circuitry of each of the two transceivers is adapted to decode data based on differential phase between successive symbols, eliminating a need for a common phase reference with the transmitter of the other transceiver.

10. The radio link as in claim 1 wherein the chips or chipsets are comprised of silicon germanium or gallium arsenide.

11. The radio link as in claim 7 wherein the receiver circuitry of each of the two transceivers is fabricated utilizing silicon complementary metal-oxide semiconductor (Si CMOS) technology.

12. The radio link as in claim 11 wherein a plurality of peripheral radio components are external to the chips or chipsets.

13. The radio link as in claim 12 wherein the plurality of peripheral radio components include some or all of the following components: fiber-optic transceivers, frequency generators, filters, power supplies and regulators, high-power amplifiers, diplexers and antenna systems.

14. The radio link as in claim 1 wherein front-end analog electronics, including amplifies, clock recovery, mixers, frequency multiplies and dividers, edge detectors, and phase comparators, and digital processing electronics, including digitizers, FPGA's, digital to analog converters, are fabricated on a single all-silicon CMOS semiconductor chips or chipsets.

15. The radio link as in claim 1 wherein the transceivers are adapted to operate in accordance with a protocol or standard chosen from the following group of protocols or standards:
SONET OC-96 (4.976 Gbps)
4×Gig-E (5.00 Gbps)
5×Gig-E (6.25 Gbps)
OBSAI RP3-01 (6.144 Gbps)
6×Gig-E (7.50 Gbps)
Fibre Channel 8GFC (8.5 Gbps)
SONET OC-192 (9.952 Gbps)
Fibre Channel 10 GFC Serial (10.52 Gbps)

16. The radio link as in claim 1 wherein the transmitters and the receivers transmit and receive through separate antennas.

17. The radio link as in claim 1 wherein the transmitters are adapted to provide a dynamic range in power output exceeding 15 dB.

18. The radio links as in claim 1 wherein the transmitter and the receiver portions of the transceivers are contained in a single enclosure.

19. The radio links as in claim 1 wherein the transmitter and the receiver portions of the transceiver are contained in separate enclosures.

20. The radio link as in claim 1 wherein the transmitters and the receivers transmit and receive through a single antenna.
